(19) United States
(12) Patent Application Publication
(10) Pub. No.: US 2010/0250436 A1
(43) Pub. Date: Sep. 30, 2010

(54) MOBILE CUSTOMER SERVICE CENTERS WITH A MOBILE PICKUP MODEL

(75) Inventors: Rebecca Loevenguth, Denver, CO (US); Sanjay Challani, East Windsor, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 12/753,694

(22) Filed: Apr. 2, 2010

Related U.S. Application Data
(63) Continuation-in-part of application No. 12/477,360, filed on Jun. 3, 2009.
Application No. 12/477,360 is a continuation-in-part of application No. 12/146,650, filed on Jun. 26, 2008.
(60) Provisional application No. 60/980,675, filed on Oct. 17, 2007.

(51) Int. Cl. G06Q 40/00

(52) U.S. Cl. 705/44

(57) ABSTRACT

Methods and systems for redirecting the funds in a money transfer transaction are provided. The redirection of funds can be accomplished through a money redirection system. The redirection process can be initiated through a request from a recipient of the funds to change the destination of the money transfer from an intended destination to a new destination. The recipient can provide the money redirection system with a transaction identifier and with recipient identification information so that the money redirection system can verify that the recipient making the money redirection request is the recipient associated with the money transfer. After the money redirection system has verified the identity of the recipient, the money redirection system can direct a money transfer facilitator to redirect the funds.

### CROSS-REFERENCES TO RELATED APPLICATIONS

This application is a continuation-in-part of U.S. patent application Ser. No. 12/477,360, filed Jun. 3, 2009, entitled “MONEY TRANSFERS UTILIZING A UNIQUE RECEIVER IDENTIFIER”, which is a continuation-in-part of U.S. patent application Ser. No. 12/146,650, filed Jun. 26, 2008, entitled “MONEY TRANSFERS UTILIZING UNIQUE RECEIVER IDENTIFIER”, which claims priority from U.S. Provisional Patent Application No. 60/980,675, filed Oct. 17, 2007, entitled “MONEY TRANSFERS UTILIZING A UNIQUE RECEIVER IDENTIFIER”, the entire disclosures of which are incorporated herein by reference for all purposes.

### BACKGROUND OF THE INVENTION

Third party money transfer services are used extensively to transfer money and pay bills through the use of wire transfers, money orders, and the like. The use of such services, however, usually requires face-to-face contact between an individual representing the third party service provider and the sender and/or the receiver. For example, if a sender is “wiring” money to a receiver, the money is typically deposited with the third party in person, and the sender typically obtains the money from the third party in person. If the money is transferred in the form of a money order, the sender typically deposits the money with the third party in person and receives a money order.

The use of mobile devices in various types of transactions is becoming more common. For example, mobile devices such as cell phones, and Personal Digital Assistants (PDAs), etc. may be used to initiate a money transfer or in some cases receive the funds of a money transfer. These devices can also be used to provide other functions with regard to financial accounts to which they may be linked or related. However, the destination(s) for the money transfer funds are generally limited to those selected by the sender of funds. For example, the sender of funds usually specifies how the funds are received, e.g. the funds are transferred to a recipient's bank account or are available for cash pickup, etc. In some instances the specified destination may place a burden on the recipient or be otherwise inconvenient. Hence, there is a need in the art for methods and systems that allow a recipient of funds to redirect the funds after the money transfer has been initiated.

### BRIEF SUMMARY OF THE INVENTION

Methods, systems, and machine-readable media are disclosed that provide transfer options to a sender and/or recipient of funds in a money transfer process including the option to redirect the funds from an intended destination to a new destination. The method may include the use of a money redirection system that is configured to receive inputs from various persons and/or entities (e.g. recipient, sender, etc.) and further configured to communicate with one or more entities (e.g. a bank, money transfer facilitator) to redirect the funds. The method can comprise the money redirection system receiving a request from a recipient to change the destination of the funds of a previously initiated money transfer. The money redirection system can perform one or more verifications of the recipient to ensure that the recipient is the person and/or entity associated with the money transfer and, if the recipient is verified, direct a money transfer facilitator to redirect the funds to a destination selected by the recipient. In making the verification, the money redirection system can receive and/or process information from a variety of sources including information from the recipient and/or sender, information from the money transfer facilitator, information from a 3^{rd} party, etc. The money redirection system can also be used by a variety of entities including a money transfer facilitator, a bank, a mobile network operator, etc.

According to one embodiment, a money redirection system may be used to redirect the funds of the money transfer from an intended destination (e.g. a recipient's bank account) to a new destination (e.g. a recipient's M-wallet). A recipient of the money transfer may interface with the money redirection system via a network, in person, etc. to send a redirection request to the money redirection system. The redirection request can include a request that the money be redirected to a new destination selected by the recipient and can include and/or be accompanied by a transaction identifier that associates and/or otherwise connects the recipient with the money transfer. The money redirection system can perform one or more verifications to ensure that the recipient is the person and/or entity associated with the money transfer. The verification can include verifying that the recipient has an account with an account provider (e.g. a bank account with a bank) and that the recipient is the person and/or entity identified by the transaction identifier.

To facilitate verification, the money redirection system can send the transaction identifier to a money transfer facilitator and, in response, receive a recipient identifier from the money transfer facilitator. The recipient identifier can include any information that aids in verifying the recipient including information about the recipient (e.g. name, social security number, etc.), the sender (name, address, etc.), the money transfer (purpose of the money transfer, etc.), etc. The money redirection system can also receive identification information from the recipient (e.g. the recipient's name, address, social security number, etc.) and compare it with other information (e.g. the recipient identifier) to verify the recipient.

To verify that the recipient has an account associated with an account provider (e.g. a M-wallet account with a mobile network operator), the money redirection system can use the recipient identification information and compare it with account information provided from a database associated with the account provider. The money redirection system may access and/or receive information from the account provider's database, which may be internal to and/or external to the money redirection system.

To verify that the recipient is the person and/or entity identified by the transaction identifier, the money redirection system can use the recipient identification information and match it with the recipient identifier. A level of certainty for an acceptable match can be defined and the money redirection system can compare the match with the level of certainty to determine if the match is acceptable. If the match is acceptable, the money redirection system can send a redirection instruction to the money transfer facilitator directing the money transfer facilitator to redirect the money transfer to the new destination.

According to another embodiment of the invention, a money redirection system may be used to redirect the funds of a money transfer from an intended destination to a new destination. The money redirection system can receive a redirection request from the recipient of the money transfer requesting that the funds of a money transfer be redirected to a new destination (e.g. to an investment account). The redirection request can include and/or be accompanied by recipient identification information (e.g. the recipient's name, address, social security number, etc.). The money redirection system can perform one or more verifications to ensure that the recipient is the person and/or entity associated with the money transfer.

The money redirection system can verify that the recipient has an account associated with an account provider (e.g. verify the recipient's investment account) by communicating with a database associated and/or maintained by the account provider and comparing the recipient identification information with the database information.

The money redirection system can receive, from the recipient, a transaction identifier that associates and/or otherwise connects the recipient with the money transfer and can verify that the recipient is the person and/or entity identified by the transaction identifier. To make the verification, the money redirection system can send the transaction identifier to a money transfer facilitator and, in response, receive a recipient identifier from the money transfer facilitator. The recipient identifier can include any information that aids in verifying the recipient including information about the recipient, the sender, the money transfer, etc.

The money redirection system can match the recipient identification information with the recipient identifier and compare the match against a pre-defined level of certainty to determine if the match is acceptable (e.g. an exact match, 95% match, etc.). If the match is acceptable, the money redirection system can send a redirection instruction to the money transfer facilitator directing the money transfer facilitator to redirect the money transfer to the new destination.

The money redirection system may be used by an agent of an entity that provides financial services (e.g. a bank employee). The recipient may interact with the agent to provide any necessary information to the money redirection system. Alternatively, the recipient may interface directly with the money redirection system such as through a network (e.g. phone, Internet, etc.), automated teller machine (ATM), etc.

The money transfer facilitator may be the entity using the money redirection system and the method may further include executing the money transfer to the new destination. Additionally, a financial institution (e.g. a bank) may be the entity using the money redirection system and the money redirection system can verify that the recipient has an account with the financial institution (e.g. a bank account) into which the funds can be redirected. Additionally, a mobile network operator may be the entity using the money redirection system and the money redirection system can verify that the recipient has an account (e.g. a M-wallet account) into which the funds can be redirected.

The money redirection system can also be used to calculate one or more fees for the money redirection service. The fee may depend on a variety of factors including: the amount of funds transferred in the money transfer, any currency conversion that may result from the redirection, a location where the money transfer redirection is initiated, a location to where the money transfer is redirected, an account or accounts to which the money transfer is redirected, etc. Further, the money redirection system can apply the fee to the money transfer amount before the money transfer redirection is executed and the fee may be paid by either the sender, the receiver, or both and may be paid upon initiation of the money redirection service or at any other time.

According to another embodiment of the invention, the money transfer redirection process can be performed by a money redirection system that comprises a communication interface and a processor. The money redirection system can be communicatively coupled with a money transfer facilitator so that the money redirection system can exchange information with the money transfer facilitator and can send a redirection instruction to the money transfer facilitator and thereby execute the money transfer redirection.

The communication interface can be adapted or configured to receive a redirection request and/or a transaction identifier from a recipient of the money transfer. The redirection request can comprise the recipient's request that the money transfer be redirected from its intended destination (e.g. an M-wallet) to a new destination (e.g. a bank account, cash pickup, etc.). The transaction identifier can associate and/or otherwise connects the money transfer with the recipient.

After receiving the redirection request and transaction identifier, the communication interface can send the transaction identifier to a money transfer facilitator. In turn, the money transfer facilitator can receive the transaction identifier, verify it, and send a recipient identifier to the money redirection system. The recipient identifier can include any information that facilitates verifying the recipient. The communication interface can also communicate with the recipient to obtain identification information from the recipient (e.g. name, social security number, etc.) that can be used to verify the identity of the recipient.

The processor can be adapted or configured to perform one or more verifications to ensure that the person and/or entity making the money redirection request is in fact the recipient. To verify the recipient's identity, the processor can verify that the recipient has an account with an account provider (e.g. a bank account) by matching the recipient identification information with information kept on a database associated with the account provider. To further verify the recipient's identity, the processor can verify that the recipient identification information provided by the recipient matches with the recipient identifier received from the money transfer facilitator. The processor can compare the matches against a pre-defined level of certainty to determine if the matches are acceptable. If the processor determines that the matches are acceptable, the communication interface can send an instruction to the money transfer facilitator to redirect the money transfer to the new destination.

The money redirection system may be used by an agent of an entity that provides financial services (e.g. a bank employee). The recipient may interact with the agent to provide any necessary information to the money redirection system. Alternatively, the recipient may interface directly with the money redirection system such as through a network (e.g. phone, Internet, etc.), automated teller machine (ATM), etc.

The money transfer facilitator may be the entity using the money redirection system and the method may further include executing the money transfer to the new destination. Additionally, a financial institution (e.g. a bank) may be the entity using the money redirection system and the money redirection system can verify that the recipient has an account with the financial institution (e.g. a bank account) into which the funds can be redirected. Additionally, a mobile network operator may be the entity using the money redirection system and the money redirection system can verify that the recipient has an account (e.g. a M-wallet account) into which the funds can be redirected.

The processor can be further configured or adapted to calculate a fee for the money redirection service. The fee may depend on a variety of factors including: the amount of funds transferred in the money transfer, any currency conversion that may result from the redirection, a location where the money transfer redirection is initiated, a location to where the money transfer is redirected, an account or accounts to which the money transfer is redirected, etc. Further, the processor may apply the fee to the money transfer amount before the money transfer redirection is executed. The fee may be paid by either the sender or the receiver and may be paid upon initiation of the money redirection service or any other time including when the funds are received by the recipient.

### BRIEF DESCRIPTION OF THE DRAWINGS

FIG. 1 is a block diagram illustrating a system for making financial transfers according to one embodiment of the present invention.

FIG. 2 is a block diagram illustrating a computer system upon which embodiments of the present invention may be implemented.

FIG. 3 illustrates a process for a “mobile-to-cash” transaction according to one embodiment of the present invention.

FIG. 4 illustrates a process for a “cash-to-mobile” transaction according to one embodiment of the present invention.

FIG. 5 illustrates a process for a “mobile-to-mobile” transaction according to one embodiment of the present invention.

FIG. 6 illustrates a process for a transaction in which the recipient enrolls “in-flight” according to one embodiment of the present invention.

FIG. 7 illustrates a process for a transaction in which the recipient elects a “cash pick-up” option according to one embodiment of the present invention.

FIG. 8 illustrates a process for a pull transaction model according to one embodiment of the present invention.

FIG. 9 is a block diagram illustrating another system for making financial transfers according to one embodiment of the present invention.

FIG. 10 illustrates a process for a money transfer redirection transaction according to one embodiment of the present invention.

FIG. 11 illustrates a process for a money transfer redirection transaction according to another embodiment of the present invention.

FIG. 12 illustrates a process for a money transfer redirection transaction according to yet another embodiment of the present invention

FIG. 13 is a block diagram illustrating a system for redirecting a money transfer according to one embodiment of the present invention.

FIG. 14 is a block diagram illustrating another system for making financial transfers according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Generally speaking, embodiments of the present invention including methods, systems, and machine-readable media are disclosed that provide transfer options to a sender and a recipient of funds in a money transfer process. The transfer options are generally one of three types: according to one embodiment, the transfer options may include facilitating remote money transfers with mobile devices and allowing “on the fly” enrollment in mobile wallet services; according to another embodiment, the transfer options may include utilizing a unique identifier to facilitate flexible payment options for the transaction; according to still another embodiment, the transfer options may include allowing a recipient to redirect the funds of a previously initiated money transfer from an intended destination to a new destination. Additionally, according to one embodiment, the transfer options may include aspects of all the transfer options described herein.

With reference to the transfer options that include facilitating remote money transfers with mobile devices and allowing “on the fly” enrollment in mobile wallet services and transfer options that, according to one embodiment, a money transfer transaction can be initiated through a variety of channels. As will be seen, a notification functionality can be provided that uses a unique customer identifier. For example, the unique customer identifier can be provided by the sender to associate the transaction with a receiver's account and/or to notify the receiver of the transaction. The notification can also provide the recipient with the ability to decide on a payout method to receive the money transfer funds. The money transfer transaction may be initiated from a retail agent location of a money transfer facilitator (such as Western Union), from a web site of the money transfer facilitator, from a telephone money transfer service of the money transfer facilitator, from a mobile money transfer send, a kiosk, an ATM or from other channels. In any of the channels, the transaction may be staged by the sender and then completed at a later time. For example, a sender can stage a transaction by calling an IVR or speaking with an operator for the money transfer facilitator to provide transaction information (e.g., sender name, receiver name, and/or amount) and then complete the transfer by visiting an Agent location and paying the transfer amount, along with applicable fees. Similarly, a sender may stage a transaction by paying for it in advance in a checkout lane and then later providing the money transfer facilitator with transaction information (e.g., by providing the transaction information via IVR, live operator and/or web page). The sender can provide the unique identifier for the recipient, which can be any public or proprietary identifier unique to the recipient. For example, the unique identifier for the receiver can be one or any combination of a mobile phone number, an email address, an instant messaging identification, a customer number, account information (e.g., stored value account identifier, bank account number and/or ABA routing number), tax number (e.g., Social Security Number or Taxpayer Identification Number), drivers' license number, state ID number, student ID number or other unique identifier. A customer number can be a preferred customer number or any other unique customer identifier issued by a money transfer facilitator, an agent of money transfer facilitator, a mobile network operator, a retailer, a bank, a service provider (e.g., payment service provider, auction service provider or Internet service provider) or any other party.

Upon receipt of the transfer request, the money transfer facilitator system can reference external and/or internal databases to identify the recipient's mobile network operator and country. The money transfer facilitator system can also determine whether the customer has enrolled in a mobile wallet and corresponding private account for the money transfer funds to be routed to. If this lookup indicates that the recipient is a mobile subscriber for a mobile network operator with whom money transfer facilitator has a relationship and is enrolled in the operator's mobile wallet, the recipient can receive an SMS or other format message notifying them that they have received a money transfer and that funds are available in their mobile wallet associated account. If the lookup indicates that the recipient is not enrolled in a mobile wallet, they can alternatively receive an SMS or other format message notifying them that they have received a mobile money transfer. The message can also ask them to either enroll in a mobile wallet to receive their funds in an associated account, to pick up cash at a retail outlet of the money transfer facilitator and/or to designate a destination for transferring funds (e.g., to bank account, investment account, stored value card or account, prepaid card or account, debit card or account, or at a kiosk or an ATM). If the lookup indicates that the recipient is a mobile subscriber for a mobile network operator with whom the money facilitator does not have a relationship, the recipient can receive a notification via SMS or other format message indicating that funds are available for pickup in cash at a cash retail outlet. Other formats for messages can include, without limitation, electronic mail, instant messaging, live operator call, prerecorded or automated voice message, or web page notification.

Stated another way, a method of supporting a money transfer transaction can comprise receiving a request to initiate the money transfer transaction. Receiving the request to initiate the money transfer transaction can comprise receiving the request from a mobile wallet application of a mobile device, from a web site of a money transfer facilitator, from a retail agent location of a money transfer facilitator, from a telephone money transfer service of a money transfer facilitator, from a kiosk, from an ATM or from another channel. The request can include a unique identifier for a recipient of the money transfer transaction. The unique identifier for the recipient of the money transfer transaction can comprise one or any combination of a phone number for a mobile device of the recipient, an email address for the recipient, an instant messaging identifier for the recipient, a preferred customer number for the recipient or other unique customer identifier issued by a money transfer facilitator or its agent, a mobile network operator, a retailer, a bank, a service provider or any other party, account information (e.g., stored value account identifier, bank account number and/or ABA routing number), a tax number (e.g., Social Security Number or Taxpayer Identification Number), a drivers' license number, a state ID number, a student ID number or another unique identifier.

A destination for transferring funds for the money transfer transaction to the recipient can be determined based at least in part on the unique identifier for the recipient. Determining the destination for transferring funds to the recipient can comprise determining a mobile network operator for the recipient and determining whether the mobile network operator for the recipient has a relationship with a money transfer facilitator supporting the money transfer transaction. If the mobile network operator for the recipient has a relationship with the money transfer facilitator, a determination can be made as to whether the recipient is enrolled in a mobile wallet service of the mobile network operator. If the recipient is enrolled in the mobile wallet service of the mobile network operator, the destination for transferring funds for the money transfer transaction to the recipient comprises an account associated with the mobile wallet service. If the recipient is not enrolled in the mobile wallet service of the mobile network operator, the destination for transferring funds for the money transfer transaction to the recipient can comprise a retail outlet of the money transfer facilitator or other designated destination. Additionally or alternatively, in response to determining the recipient is not enrolled in the mobile wallet service of the mobile network operator, a message can be sent to the recipient inviting the recipient to enroll in the mobile wallet service. If the recipient enrolls in the mobile wallet service of the mobile network operator, the destination for transferring funds for the money transfer transaction to the recipient can comprise an account associated with the mobile wallet service. If the mobile network operator for the recipient does not have a relationship with the money transfer facilitator, the destination for transferring funds for the money transfer transaction to the recipient can comprise a retail outlet of the money transfer facilitator or other designated destination.

Once the destination for transferring funds for the money transfer transaction to the recipient has been determined, the funds can be transferred to the determined destination and the recipient can be notified of availability of funds at the determined destination. Notification can be sent by a money transfer facilitator to the recipient and/or to any party associated with the designated destination (e.g., to a mobile network operator, a retailer, a bank, a service provider (e.g., payment service provider, auction service provider or Internet service provider) or any other party).

Such a system allows a money transfer facilitator, using a unique customer identifier and internal and/or external mapping databases, to provide a structured settlement between unrelated entities such as the sending mobile wallet and receiving mobile wallet, or between the sending cash retail location and receiving mobile wallet. It need not be a closed-loop system that allows mobile remittances only for consumers who are enrolled in the same mobile wallet system but rather allows entities that are unrelated to allow their enrolled consumers to send a mobile money transaction to a consumer either enrolled under another entity or not enrolled—in which case they are able to enroll in a mobile wallet service, pick up cash at a retail location of the money transfer facilitator or other cash retail outlet or designate a destination for receipt of the money transfer.

With reference to the transfer options that include utilizing a unique identifier to facilitate flexible payment options for the transaction, according to one embodiment, a pull transaction model can additionally or alternatively be implemented. According to such embodiments, a money transfer can be initiated in a conventional manner via an agent of a money transfer facilitator. The sender of the transfer can provide an identifier for the transaction to the recipient. The recipient can in turn use the identifier, in combination with the functionality of a mobile wallet application of a mobile device to request or “pull” the money transfer to an account associated with the mobile wallet application. In this way, the recipient can receive the transfer to the mobile wallet account even if the sender does not know that such a delivery is available.

Stated another way, supporting a money transfer transaction can comprise receiving a Personal Identification Number (PIN) and a transaction identifier for a previously initiated money transfer transaction at a mobile wallet application. The PIN can be verified with the mobile wallet application and, in response to verifying the PIN, the transaction identifier can be sent to an application of a money transfer facilitator supporting the money transfer transaction.

The application of the money transfer facilitator can in turn receive and verify the transaction identifier. In response to verifying the transaction identifier, the application of the money transfer facilitator can send a recipient identifier to the mobile wallet application. The recipient identifier can indicate an intended recipient of the money transfer transaction.

The recipient identifier from the application of the money transfer facilitator can be received at the mobile wallet application. The mobile wallet application can then validate the recipient identifier. In response to validating the recipient identifier, a payment request can be sent from the mobile wallet application to the application of the money transfer facilitator.

The payment request can be received at the application of the money transfer facilitator and the money transfer transaction can be completed based at least in part on the payment request. In some cases, the payment request can indicate at least one destination account for the money transfer transaction. In such cases, completing the money transfer transaction can comprise crediting the at least one destination account indicated by the payment request. Alternatively, the payment request can indicate a plurality of destination accounts for the money transfer transaction. In such cases, the payment request may further indicate a distribution of funds of the money transfer transaction to each of the destination accounts. In such cases, completing the money transfer transaction can comprise crediting each of the destination accounts indicated by the payment request and can be based on the distribution indicated by the payment request.

A response can be sent to the mobile wallet application from the application of the money transfer facilitator. The response can indicate completion of the money transfer transaction. The mobile wallet application can receive the response message from the application of the money transfer facilitator. A balance maintained by the mobile wallet application can be updated based on the response indicating completion of the money transfer transaction. In some cases, a notification can be provided to a user of the mobile wallet application. For example, the notification can indicate the updated balance.

According to yet another embodiment, a system can comprise a mobile communications network and a mobile device communicatively coupled with the mobile communications network. The mobile device can execute a mobile wallet application. The mobile wallet application can be adapted to receive a Personal Identification Number (PIN) and a transaction identifier for a previously initiated money transfer transaction, verify the PIN, and in response to verifying the PIN, send the transaction identifier via the mobile communications network. The system can also include a money transfer facilitator system communicatively coupled with the mobile communications network. The money transfer facilitator system can be adapted to receive the transaction identifier from the mobile wallet application, verify the transaction identifier with, and in response to verifying the transaction identifier, send a recipient identifier to the mobile wallet application via the mobile communications network, the recipient identifier indicating an intended recipient of the money transfer transaction.

The money transfer facilitator system can further comprise one or more interfaces for conducting money transfer transactions and a transfer options module communicatively coupled with the one or more interfaces. The transfer options module can be adapted to receive transaction information for a money transfer transaction from a sender through at least one or the interfaces, provide a notification of the transaction to a recipient of the transaction, and select one or more delivery options for completing the money transfer transaction.

As noted above, embodiments of the present invention provide methods and systems for supporting money transfer transactions initiated by and/or conducted through a variety of channels but are not limited to a wireless communication channel or systems including or using a wireless communication device. Therefore, according to still another embodiment, a money transfer facilitator system can comprise one or more interfaces for conducting money transfer transactions and a transfer options module communicatively coupled with the one or more interfaces. For example, the one or more interfaces can comprise at least one of an Interactive Voice Response (IVR) interface, a web interface, an interface to an agent system, or other interface. The transfer options module can be adapted to receive transaction information for a money transfer transaction from a sender through at least one or the interfaces, provide a notification of the transaction to a recipient of the transaction, and select one or more delivery options for completing the money transfer transaction. For example, the delivery options can comprise at least one of delivering funds to a bank account of a recipient, delivering funds to a pre-paid account, delivering funds to a funds withholding system, delivering funds to a third party, delivering a draft check, delivering funds through an Automated Teller Machine (ATM), and other options.

In some cases, the transfer options module can receive an indication of delivery options from a recipient of the money transfer transaction and select one or more delivery options based on the indication. For example, the money transfer options module can receive the indication of delivery options from the recipient via one of the interfaces. In other cases, the transfer options module can additionally or alternatively select one or more delivery options based on one or more delivery rules. For example, the one or more delivery rules can include one or more rules defined by a recipient of the money transfer transaction, one or more rules defined by a sender of the money transfer transaction, and/or one or more rules defined by the money transfer facilitator. In some cases, the notification of the transaction can include an indication of one or more delivery options. In such cases, the transfer options module may define a delivery rule based on the indication of delivery options received from the recipient and may selects one or more delivery options for completing a subsequent money transfer transaction based on the delivery rule.

Regarding the transfer options that include allowing a recipient to redirect the funds of a previously initiated money transfer from an intended destination to a new destination, according to one embodiment, a transfer redirection model can additionally or alternatively be implemented. According to such embodiments, a money transfer can be initiated in a conventional manner such as through a mobile device, an agent of the money transfer facilitator, or any other method described herein. The sender of the funds generally specifies an account or destination where the funds will be transferred to. The destination or account may be selected by the sender alone or may be selected with the help of the recipient of the funds. After the money transfer has been initiated, the recipient may use a money redirection system to redirect the money transfer from the intended destination or account selected by the sender to a new destination or account. In some instances, the new destination may be more convenient because of proximity, changed circumstances, and the like.

Additionally, the money redirection system is typically used by an entity or account provider that provides money services, such as a bank or money transfer facilitator, etc. For example, the entity or account provider may be a bank that the recipient holds an account with or the entity may be a money transfer facilitator that the sender used to initiate the money transfer. The recipient may interface or otherwise communicate with the money redirection system in any manner such as through a mobile device, through an agent of the entity using the money redirection system, through a web page of the entity using the money redirection system, etc. For example, in some embodiments the recipient communicates in person with an agent of the entity using the money redirection system. In other embodiments, the recipient communicates with the money redirection system through a communication interface such as through the entity's webpage or Interactive Voice Response (IVR) phone system, etc.

After the sender initiates the money transfer, the sender may notify the recipient of the money transfer and send the recipient a transaction identifier for the money transfer. The transaction identifier can include any combination of information, such as a social security number, birthday, etc., that identifies the money transfer with the recipient. Upon receiving the notice and the transaction identifier, the recipient may then send the money redirection system a request to change the destination of the funds from the intended destination selected by the sender to a new destination selected by the recipient. The recipient's determination to redirect the funds may be made before or after the recipient receives the notice and transaction identifier.

At some point during the redirection of the funds, the recipient provides the transaction identifier to the money redirection system such as by providing the transaction identifier to an agent of the entity. The money redirection system receives the transaction identifier and, in response, provides the transaction identifier to the money transfer facilitator. The money transfer facilitator receives the transaction identifier, verifies it, and sends a recipient identifier to the money redirection system. Additionally, at some point during the redirection of the funds, the recipient provides the money redirections system with identification information of the recipient. For example, the recipient may provide the money redirection system with details about themselves or about the entity if the recipient is an entity instead of an individual. The recipient may provide information such as a name, social security number, account number, birth date, or information about the sender and/or the purpose of the money transfer, or any other information. The recipient may provide the recipient identification information in person to the agent of the entity or account provider or use any means to send the recipient identification information to the money redirection system.

The money redirection system then makes one or more verifications to ensure that the recipient making the money redirection request is in fact the recipient of the money transfer. The money redirection system can verify that the recipient is associated with the entity or account provider. The money redirection system may use the recipient identification information to make the verification. For example, the recipient may be using a bank to redirect the funds and the money redirection system may use the recipient identification information to verify that the recipient has an account with the bank. The money redirection system can also verify that the recipient is the person or entity that the sender is intending to send the funds to. The money redirection system uses the recipient identifier and the recipient identification information to verify that the recipient identifier matches with the recipient identification information. In this manner, the money redirection system is thus able to use third party information to verify that the recipient making the money redirection request is the recipient of the money transfer. The match may be made in a variety of ways, for example, an agent of the entity or account provider may ask the recipient a series of questions and input the recipient's answer into the money redirection system, or the recipient can input the recipient identification information into the money redirection system via one of the many interfaces the money redirection system can make the match.

To ensure that the match is acceptable, a level of certainty may be defined and the money redirection system may compare the match with the level of certainty. For example, the level of certainty may be defined so that the recipient identification information must match with the recipient identifier exactly or may allow for a few minor discrepancies between the recipient identification information and the recipient identifier. After the verification is deemed acceptable, the money redirection system may then sender a redirection instruction or otherwise notify the money transfer facilitator that the funds of the money transfer are to be redirected from the intended destination to the new destination. The money transfer facilitator may communicate with a financial transfer network to redirect the funds as described herein. Additional details of various embodiments of the present invention will be described below with reference to the figures.

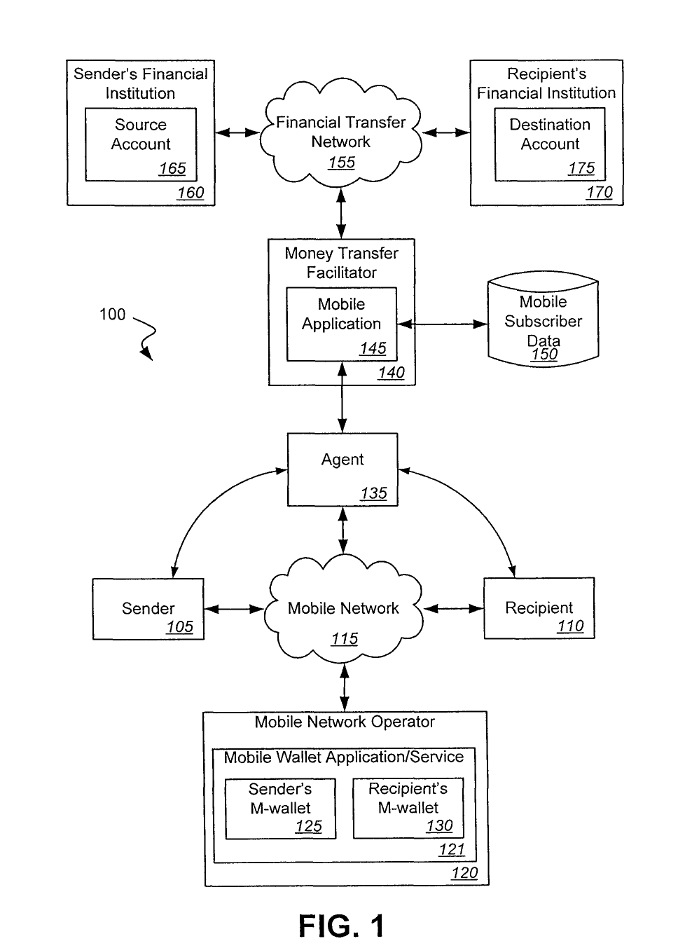

FIG. 1 is a block diagram illustrating a system for making financial transfers according to one embodiment of the present invention. As illustrated here, the system 100 can include a money transfer facilitator 140 system such as the systems operated by Western Union or another money transfer facilitator service. The money transfer facilitator 140 can be communicatively coupled with a financial transfer network 155. Also communicatively coupled with the financial transfer network 155 can be one or more financial institutions 160 and 170. Generally speaking and as understood by one skilled in the art, the money transfer facilitator 140 may access a source account 165 of one financial institution 160 and/or a destination account 175 of the same or a different financial institution 170 to affect a transfer from and/or to the accounts 165 and 175 via the financial transfer network 155.

The money transfer facilitator system 140 can also include or execute a mobile application 145. As will be seen, the mobile application 145 of the money transfer facilitator can be adapted to support transaction involving one or more mobile devices. Generally speaking, the mobile application 145 can be adapted to identify the entities and/or accounts associated with a transaction and/or determine a destination for a payment of the transaction. For example, the entities and/or accounts can be identified based on a set of mobile subscriber data 150 maintained in a database or other repository. It should be noted that, while illustrated here as separate from the money transfer facilitator system 140, the mobile subscriber data 150 need not be separated from the money transfer facilitator system 140. Rather, the mobile subscriber data 150 can be either internal to or external from the money transfer facilitator system 140 depending upon the exact implementation.

The system can also include an agent 135 in communication with the money transfer facilitator 140. The agent 135 can comprise a retail outlet location and associated systems of the money transfer facilitator 140. Generally speaking, the agent 135 provides a channel by which entities can access the services of the money transfer facilitator 140. It should also be noted that, while not illustrated here for the sake of simplicity and clarity, the agent 135 and/or money transfer facilitator 140 can also provide other channels for accessing the services of the money transfer facilitator 140. For example, such channels can include but are not limited to a web site, a telephone service, a kiosk, an ATM or other channels. Generally speaking and as understood by one skilled in the art, via one or more such channels, a sender 105 can initiate a transaction to transfer money to a recipient 110. For example, a sender 105 can access the services of the money transfer facilitator 140 via a web site of the money transfer facilitator 140 and initiate a money transfer from a source account 165 owned by the sender 105. The recipient 110 of the payment may then, for example, pick up the payment from the agent's 135 retail location.

The system 100 can also include a mobile network 115, such as a cellular or other wireless network, communicatively coupled with the agent 135 and/or the money transfer facilitator 140. A mobile network operator system 120 can be communicatively coupled with the mobile network 115. As understood by one skilled in the art, the mobile network 115 and mobile network operator system 120 can support communication to and/or from mobile devices communicatively coupled therewith such as a mobile device associated with the sender 105 and/or a mobile device associated with the recipient 110. It should be noted that the names sender and recipient are used only to illustrate a particular entity's and/or device's function at a given time and are not intended to imply any limitations on the functions that can be performed by a given entity and/or device. That is, any given entity and/or device associated with that entity can alternately act as sender or recipient. Also, it should be understood that while only one mobile network 115 and mobile network operator 120 are illustrated here for the sake of simplicity and clarity, multiple mobile networks 115 and mobile network operators 120 may be present. In some cases, the mobile network and mobile network operator of the sender 105 may be different from the mobile network and mobile network operator of the recipient 110.

The mobile network operator system 120 can include and/or execute a mobile wallet application 120 or service. Generally speaking, the mobile wallet application 121 maintains mobile wallets 125 and 130 for one or more subscribers, such as the sender 105 and/or recipient 110 to the mobile wallet service 121. The mobile wallets 125 and 130 can each comprise information related to the device and accounts of the entity for which the mobile wallet is maintained. For example, the sender's mobile wallet 125 can maintain information identifying the sender's 105 mobile device, one or more accounts 165 associated with the mobile wallet, and other possible identifying information. Similarly, the recipient's mobile wallet 130 can maintain information identifying the recipient's 110 mobile device, one or more accounts 175 associated with the mobile wallet, and other possible identifying information.

According to one embodiment, the money transfer facilitator 140 can receive a request to initiate the money transfer transaction, for example a payment from the sender 105 to the recipient 110. The money transfer facilitator 140 can receive the request to initiate the money transfer transaction from the mobile wallet application 121 of a mobile network operator 120, from a web site of the money transfer facilitator 140, from the agent 135, from a telephone money transfer service of the money transfer facilitator 140, from a kiosk, from an ATM or from another channel. The request can include a unique identifier for the recipient 110 of the money transfer transaction. The unique identifier for the recipient 110 can comprise one or any combination of a phone number for a mobile device of the recipient, an email address for the recipient, an instant messaging identifier for the recipient, a preferred customer number for the recipient or other unique customer identifier issued by a money transfer facilitator 140 or its agent 135, the mobile network operator 120, a retailer, a bank, a service provider or any other party, account, information (e.g., stored value account identifier, bank account number and/or ABA routing number), a tax number (e.g., Social Security Number or Taxpayer Identification Number), a drivers' license number, a state ID number, a student ID number or another unique identifier.

A destination for transferring funds for the money transfer transaction to the recipient 110 can be determined by the money transfer facilitator 140, agent 135, and/or mobile network operator 120 based at least in part on the unique identifier for the recipient 110. Determining the destination for transferring funds to the recipient 110 can comprise identifying mobile network operator 120 for the recipient 110 and determining whether the mobile network operator 120 for the recipient 110 has a relationship with the money transfer facilitator 140 supporting the money transfer transaction. If the mobile network operator 120 for the recipient 110 has a relationship with the money transfer facilitator 140, a determination can be made as to whether the recipient 110 is enrolled in a mobile wallet service 121 of the mobile network operator 120. If the recipient 110 is enrolled in the mobile wallet service 121 of the mobile network operator 120, the destination for transferring funds for the money transfer transaction to the recipient 110 can comprise an account 175 associated with the mobile wallet 130 of the recipient. If the recipient 110 is not enrolled in the mobile wallet service 121 of the mobile network operator 120, the destination for transferring funds for the money transfer transaction to the recipient 110 can comprise a retail outlet of the money transfer facilitator or other designated destination, e.g., the agent's 135 location. Additionally or alternatively, in response to determining the recipient 110 is not enrolled in the mobile wallet service 121 of the mobile network operator 120, a message can be sent to the recipient 110 inviting the recipient 110 to enroll in the mobile wallet service 121. If the recipient 110 enrolls in the mobile wallet service 121 of the mobile network operator 120, the destination for transferring funds for the money transfer transaction to the recipient 110 can comprise an account 175 associated with the mobile wallet 130 of the recipient 110. If the mobile network operator 121 for the recipient 110 does not have a relationship with the money transfer facilitator 140, the destination for transferring funds for the money transfer transaction to the recipient 110 can comprise retail outlet of the money transfer facilitator or other designated destination e.g., the agent's 135 location.

Once the destination for transferring funds for the money transfer transaction to the recipient 110 has been determined, the funds can be transferred to the determined destination and the recipient 110 can be notified of availability of funds at the determined destination. Notification can be sent by a money transfer facilitator 140 to the recipient 110 and/or to any party associated with the designated destination (e.g., to a mobile network operator 120, a retailer, a bank, a service provider (e.g., payment service provide, auction service provider or Internet service provider) or any other party).

Such a system 100 allows a money transfer facilitator 140, using a unique customer identifier and internal and/or external mapping databases 150, to provide a structured settlement between unrelated entities such as the sending mobile wallet 125 and receiving mobile wallet 130, or between the sending cash retail location and receiving mobile wallet 130. It need not be a closed-loop system that allows mobile remittances only for consumers who are enrolled in the same mobile wallet system but rather allows entities that are unrelated to allow their enrolled consumers to send a mobile money transaction to a consumer either enrolled under another entity or not enrolled—in which case they are able to enroll in a mobile wallet service, pick up cash at a retail location of the money transfer facilitator or other cash retail outlet or designate a destination for receipt of the money transfer.

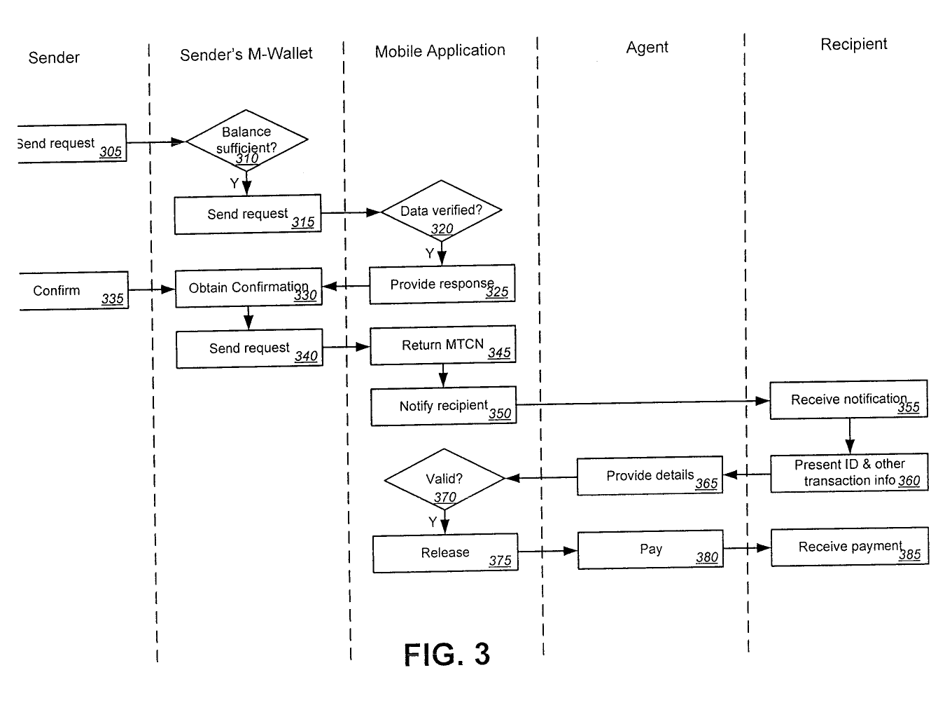

Stated another way, embodiments of the present invention provide for financial transfers utilizing a unique identifier to facilitate flexible payment delivery options for the transaction. For example, one option can comprise a “mobile-to-cash” option in which the user of a mobile device initiates a transaction paid from an account associated with a mobile wallet of that user to a recipient that can receive the payment in cash, for example from an agent of the money transfer facilitator. Another option can comprise a “cash-to-mobile” option in which an entity pays for and initiates a transaction in person, for example via an agent of the money transfer facilitator, and wherein the payment is delivered to an account associated with a mobile wallet of the recipient. Yet another option can comprise a “mobile-to-mobile” option in which the user of a mobile device initiates a transaction paid from an account associated with a mobile wallet of that user wherein the payment is delivered to an account associated with a mobile wallet of the recipient. These options can include variations such as an option to allow a user of a mobile device to enroll “on the fly.” That is, if a transaction involves a recipient is not currently enrolled in a mobile service that allows mobile delivery of payments, i.e., payment to an account associated with a mobile wallet, the recipient may be provided with a notice of availability of the payment and an opportunity to enroll in the service and receive the payment at that time. Each of these options will be described below in more detail with reference to FIGS. 3-7.

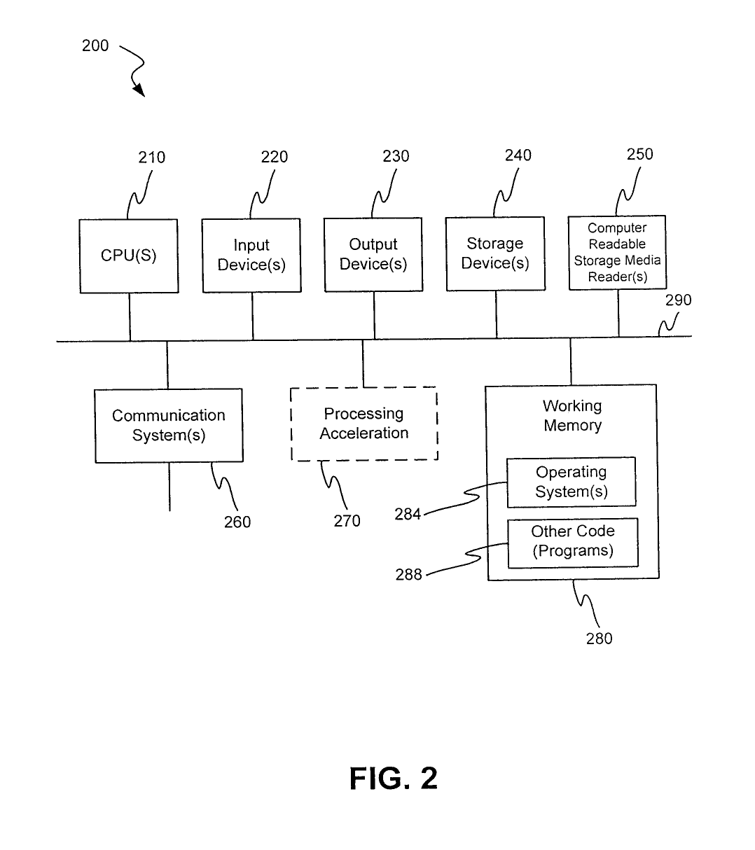

FIG. 2 is a block diagram illustrating a computer system upon which embodiments of the present invention may be implemented. This example illustrates a computer system 200 such as may be used, in whole, in part, or with various modifications, to provide the functions of the sender's mobile device, the receiver's mobile device, the agent 135 system, the money transfer facilitator system 140, the mobile network operator system 120, and/or other components of the invention such as those discussed above.

The computer system 200 is shown comprising hardware elements that may be electrically coupled via a bus 290. The hardware elements may include one or more central processing units 210, one or more input devices 220 (e.g., a mouse, a keyboard, etc.), and one or more output devices 230 (e.g., a display device, a printer, etc.). The computer system 200 may also include one or more storage device 240. By way of example, storage device(s) 240 may be disk drives, optical storage devices, solid-state storage device such as a random access memory (“RAM”) and/or read-only memory (“ROM”), which can be programmable, flash-updateable and/or the like.

The computer system 200 may additionally include a computer-readable storage media reader 250, a communications system 260 (e.g., a modem, a network card (wireless or wired), an infra-red communication device, Bluetooth™ device, cellular communication device, etc.), and working memory 280, which may include RAM and ROM devices as described above. In some embodiments, the computer system 200 may also include a processing acceleration unit 270, which can include a digital signal processor, a special-purpose processor and/or the like.

The computer-readable storage media reader 250 can further be connected to a computer-readable storage medium, together (and, optionally, in combination with storage device(s) 240) comprehensively representing remote, local, fixed, and/or removable storage devices plus storage media for temporarily and/or more permanently containing computer-readable information. The communications system 260 may permit data to be exchanged with a network, system, computer and/or other component described above.

The computer system 200 may also comprise software elements, shown as being currently located within a working memory 280, including an operating system 284 and/or other code 288. It should be appreciated that alternate embodiments of a computer system 200 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 200 may include code 288 for implementing any or all of the function of the various elements of the architecture as described herein. For example, software, stored on and/or executed by a computer system such as system 200, can provide the functions of the sending subscriber interface, the receiving subscriber interface, the agent server 125, the source transfer network 165, the primary transfer network 160, the destination transfer network 190, the communication network 115, and/or other components of the invention such as those discussed above.

As noted above, embodiments of the present invention provide for financial transfers utilizing a unique identifier to facilitate flexible payment delivery options for the transaction. For example, one option can comprise a “mobile-to-cash” option in which the user of a mobile device initiates a transaction paid from an account associated with a mobile wallet of that user to a recipient that can receive the payment in cash, for example from an agent of the money transfer facilitator. Another option can comprise a “cash-to-mobile” option in which an entity pays for and initiates a transaction in person, for example via an agent of the money transfer facilitator, and wherein the payment is delivered to an account associated with a mobile wallet of the recipient. Yet another option can comprise a “mobile-to-mobile” option in which the user of a mobile device initiates a transaction paid from an account associated with a mobile wallet of that user wherein the payment is delivered to an account associated with a mobile wallet of the recipient. These options can include variations such as an option to allow a user of a mobile device to enroll “on the fly.” That is, if a transaction involves a recipient is not currently enrolled in a mobile service that allows mobile delivery of payments, i.e., payment to an account associated with a mobile wallet, the recipient may be provided with a notice of availability of the payment and an opportunity to enroll in the service and receive the payment at that time. Each of these options will be described below in more detail with reference to FIGS. 3-7.

FIG. 3 illustrates a process for a “mobile-to-cash” transaction according to one embodiment of the present invention. In this example, the process begins with a sender 105 initiating a money transfer by sending 305 a request to a mobile wallet application 121 of the sender's mobile network operator 120. Although, FIG. 3 depicts the process beginning with the sender initiating the money transfer through a mobile wallet application, the money transfer process could be initiated through any money transfer mechanism (e.g. providing cash to an agent 135, initiating the process through an online account and/or with a credit or debit card, etc.) At block 310, the mobile wallet application 121 can check a current balance of the account 165 associated with the sender's mobile wallet 125 and, if the funds in the account 165 associated with the sender's mobile wallet 125 are sufficient for the transfer, the mobile wallet application 121 can in turn send 315 a request to a mobile application 145 of the money transfer facilitator 140. This request can include, for example, information identifying the send, information identifying the recipient, transaction information, e.g., amount, etc. and/or other information. While FIG. 3 describes the process beginning with a sender 105 initiating a money transfer by sending a request to a mobile wallet application 121 of the sender's mobile network operator 120, it should be appreciated that a sender 105 can begin the process by initiating a money transfer through a money transfer facilitator 140 (or its agent 135), which then queries a mobile network operator 120 whether sufficient funds are available in the account 160 associated with the mobile wallet 125 of the sender.

The mobile application 145 of the money transfer facilitator 140, upon receiving the request, can perform a process to look up (e.g., a Mobile Station Integrated Service Digital Network (MSISDN), International Mobile Subscriber Identity (IMSI) and/or Temporary Mobile Subscriber Identity (TMSI)) for the sender 105 and/or recipient 110 and/or otherwise verify 320 the data provided by the mobile wallet application 121 in the request. The mobile application 145 of the money transfer facilitator 140 can then provide 325 a response to the request from the mobile wallet application 121. If the data of the request is verified by the mobile application 145 of the money transfer facilitator 140, the response may include information related to and/or describing fees, legal notices, etc. Alternatively or additionally, the look up can be performed by the mobile network operator 120.

The mobile wallet application 121, upon receiving the response from the mobile application 145 of the money transfer facilitator 140 can obtain 330 and 335 confirmation of the transaction from the sender 105. Upon confirmation 330 and 335, the mobile wallet application 121 can in turn send 340 a transfer request to the mobile application 145 of the money transfer facilitator 140.

Upon receipt of the transfer request, the mobile application 145 of the money transfer facilitator 140 can initiate a money transfer send process which returns 345 a transaction identifier (e.g., Money Transfer Control Number (MTCN)) to the mobile wallet application 121 indicating that the transaction is available for payout. Additionally, the mobile application 145 of the money transfer facilitator 140 can send 350 a notification of the transaction and the availability of funds to the recipient 110.

The recipient 110, after receiving 355 the notification, can present 360 an identification, the MSISDN, the MTCN, answer to a security question and/or other information to an agent 135 of the money transfer facilitator, e.g., at a retail outlet of the money transfer facilitator 140. The agent 135 of the money transfer facilitator 140 can in turn submit 365 this information and/or routing details for the transfer to the mobile application 145 of the money transfer facilitator 140. The mobile application 145 of the money transfer facilitator 145 can then perform a validation 370 of the data provided by the agent 135 and, if valid, perform a money transfer release process 375 to route the money transfer and/or instruct the agent 135 to pay 380 and 385 the transaction to the recipient 110.

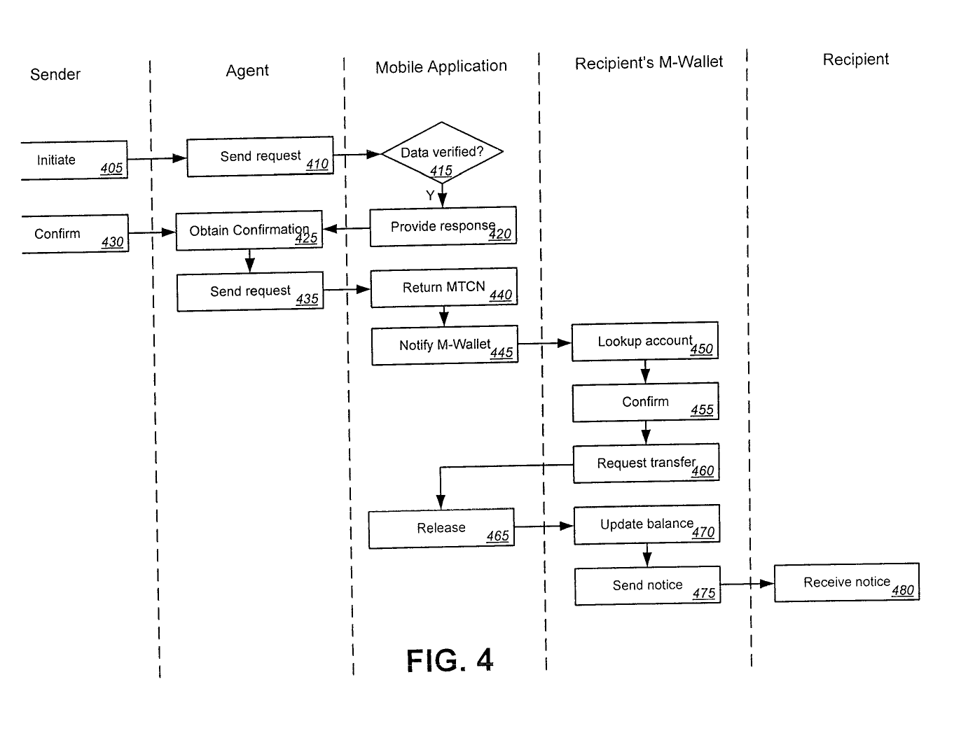

FIG. 4 illustrates a process for a “cash-to-mobile” transaction according to one embodiment of the present invention. In this example, the process begins with a sender 105 initiating 405 a money transfer via an agent 135 of the money transfer facilitator 140, e.g., a retail outlet. That is, the sender 105 can pay cash to the agent 135, and provide an identifier for the recipient 110 of the transfer. For example, the process also could begin with a sender 105 initiating a money transfer via a website, telephone, kiosk, ATM, in-lane at a retailer or through any other channel and paying for the transfer and applicable fees through any available funding source (e.g., credit card or account, ATM or debit card or account, prepaid card or account, smart card, check, electronic check, travelers check, money order or through an Automated Clearing House). The money transfer facilitator 140 (or its agent 135) can in turn submit 410 a request to a money transfer facilitator 140 mobile application 145.

The money transfer facilitator 140 mobile application 145 can in turn perform a process to look up (e.g., an MSISDN, IMSI and/or TMSI) for the recipient 110 and/or otherwise verify 415 the data provided by the sender 105. The mobile application 145 of the money transfer facilitator 140 can then provide a response 420 to the request from the money transfer facilitator 140 or its agent 135. If the data of the request is verified by the mobile application 145 of the money transfer facilitator 140, the response may include information related to and/or describing fees, legal notices, etc. Alternatively or concurrently, the look up can be performed by the mobile network operator 120.

The agent 135 can in turn request confirmation 425 of the transaction from the sender 105. Upon confirmation 430 of the transaction by the sender 105, the agent 135 of the money transfer facilitator 140 can send 435 a transfer request to the mobile application 145 of the money transfer facilitator 140.

Upon receipt of the transfer request, the mobile application 145 of the money transfer facilitator 140 can initiate a money transfer send process which returns 440 an MTCN to the agent 135. Additionally, the mobile application 145 of the money transfer facilitator 140 can send 445 a notification of the transaction and the availability of funds to the mobile wallet 130 of the recipient 110 and/or to the mobile network operator 120.

The mobile wallet application 121, upon receiving the notification from the mobile application 145 of the money transfer facilitator 140, can execute a look-up 450 account process to determine an account 175 associated with the mobile wallet 130 into which the funds should be transferred. Once this account is identified, the mobile wallet 130 can send a message to the mobile application 145 of the money transfer facilitator 140 confirming 455 the recipient 110. Additionally, the mobile wallet 130 can send 460 a message to the mobile application 145 of the money transfer facilitator 140 to initiate the receipt, i.e., the transfer of funds to the identified account 175.

Upon receipt of the transfer request, the mobile application 145 of the money transfer facilitator 140 can perform a money transfer release process 465. The process 465 can perform a transfer of the funds to the identified account 175 of the recipient 110 and send a message to the mobile wallet application 121 indicating success or failure of the transfer. The mobile wallet application 121 can in turn update 470 a balance of the account, assuming a successful transfer, and notify 475 and 480 the recipient of the transfer.

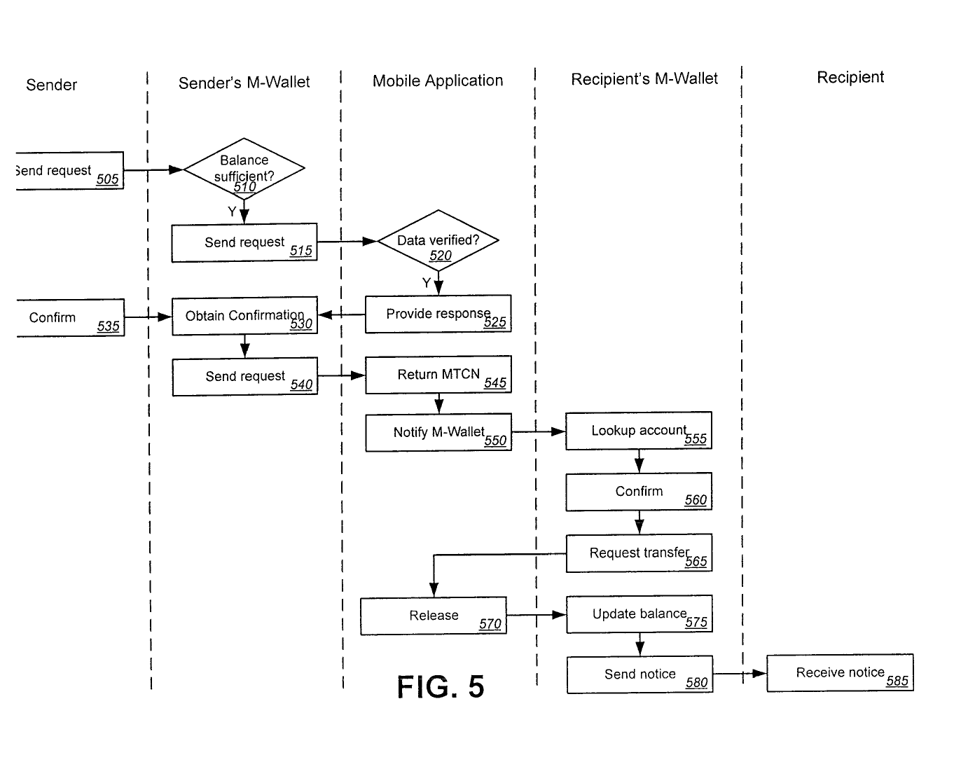

FIG. 5 illustrates a process for a “mobile-to-mobile” transaction according to one embodiment of the present invention. In this example, the process begins with a sender 105 initiating a money transfer by sending 505 a request to a mobile wallet application 121 of the sender's mobile network operator 120. The mobile wallet application 121 of the sender 105 can check 510 a current balance of the account 165 associated with the sender's mobile wallet 125 and, if 510 the funds in the account 165 associated with the sender's mobile wallet 125 are sufficient for the transfer, the mobile wallet application 121 can in turn send 515 a request to a mobile application 145 of the money transfer facilitator 140. This request can include, for example, information identifying the sender 105, information identifying the recipient 110, transaction information, e.g., amount, etc. and/or other information.

The mobile application 145 of the money transfer facilitator 140, upon receiving the request, can perform a process to look up (e.g., via MSISDN, IMSI and/or TMSI) for the sender 105 and/or recipient 110 and/or otherwise verify 520 the data provided by the mobile wallet application 121 of the sender 105 in the request. The mobile application 145 of the money transfer facilitator 140 can then provide a response 525 to the request from the mobile wallet application 121 of the sender 110. If the data of the request is verified by the mobile application 145 of the money transfer facilitator 140, the response may include information related to and/or describing fees, legal notices, etc. Alternatively or additionally, the look up can be performed by the mobile network operator 120.

The mobile wallet application 121 of the sender 110, upon receiving the response from the mobile application 145 of the money transfer facilitator 140 can obtain confirmation 530 and 535 of the transaction from the sender 105. Upon confirmation 530 and 535, the mobile wallet application 121 of the sender 105 can in turn send 540 a transfer request to the mobile application 145 of the money transfer facilitator 140.

Upon receipt of the transfer request, the mobile application 145 of the money transfer facilitator 140 can initiate a money transfer send process which returns 545 a Money Transfer Control Number (MTCN) to the mobile wallet application 121 indicating that the transaction is available for payout. The mobile application 145 of the money transfer facilitator 140 can also send 550 a message to the mobile wallet 130 of the recipient 110 and/or to the mobile network operator 120 indicating availability of the funds for transfer.

The mobile wallet application 121 of the recipient 110, upon receiving the notification from the mobile application 145 of the money transfer facilitator 140, can execute a look-up account process 55 to determine an account 175 associated with the mobile wallet 130 into which the funds should be transferred. Once this account is identified, the mobile wallet 130 of the recipient 110 can send 560 a message to the mobile application 145 of the money transfer facilitator 140 confirming the recipient. Additionally, the mobile wallet 130 of the recipient 110 can send 565 a message to the mobile application 145 of the money transfer facilitator 140 to initiate the receipt, i.e., transfer of funds to the identified account 175.

Upon receipt of the transfer request, the mobile application 145 of the money transfer facilitator 140 can perform a money transfer release process 570. The process 570 can perform a transfer of the funds to the identified account 175 of the recipient 110 and send a message to the mobile wallet application 121 of the recipient 110 indicating success or failure of the transfer. The mobile wallet application 121 of the recipient 110 can in turn update 575 a balance of the account, assuming a successful transfer, and notify 580 and 585 the recipient 110 of the transfer.

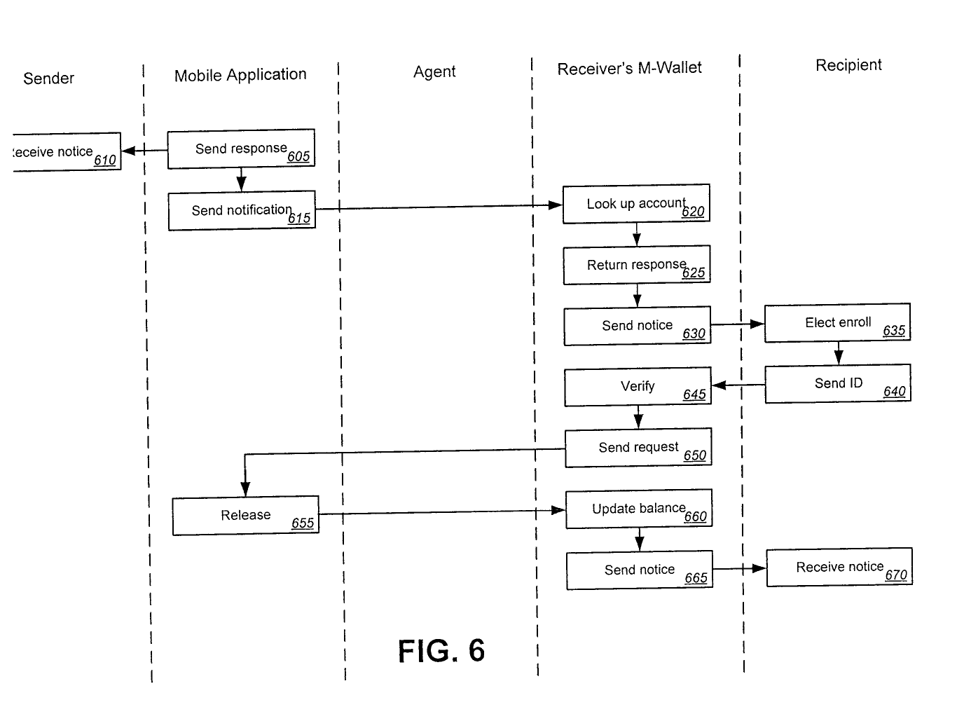

FIG. 6 illustrates a process for a transaction in which the recipient enrolls “in-flight” according to one embodiment of the present invention. In this example, processing begins after the money transfer send process has been initiated by the mobile application 145 of the money transfer facilitator 140 as described in the examples above. At this point, the mobile application 145 of the money transfer facilitator 140 can send 605 and 610 a response message to the sender 105, either the agent 135 of the money transfer facilitator 140 or the mobile wallet 125 of the sender 105, indicating the MTCN and/or that the transaction is available for payout. Also, the mobile application 145 of the money transfer facilitator 140 can send 615 a message to the mobile wallet application 121 of the recipient's 110 mobile network operator 120 indicating availability of the funds for transfer.

Upon receipt of the message indicating availability of the funds for transfer, the mobile wallet application 121 of the recipient's 120 wireless network operator 120 can perform a look up process 620 to attempt to identify an account 175 associated with the recipient's 110 mobile wallet 130. However, if the recipient 110 does not have a mobile wallet, i.e., the recipient 110 does not subscribe to or enroll in that service, the mobile wallet application 121 of the recipient's network operator 120 can return 625 a response to the mobile application 145 of the money transfer facilitator 140 indicating that the recipient 110 does not have an account/wallet. Additionally, the mobile wallet application 121 of the recipient's mobile network operator 120 and/or money transfer facilitator 140 can send 630 a message to the recipient 110, e.g., via the recipient's mobile device, notifying the recipient 110 of the availability of funds and inviting the recipient 110 to enroll in the mobile wallet service to receive the transfer.

The recipient 110 can then elect, for example, via the recipient's mobile device, to enroll in the service to receive the funds transfer, to pick up the funds at an agent 135 of the money transfer facilitator 140 or to designate a destination for receiving the money transfer. If the recipient elects to enroll 635, the recipient 110 can provide 640 some identifying information to the mobile wallet application 121. The mobile wallet application 121 can in turn perform a search or verification process 645. Upon successful completion of this process, the mobile wallet application 121 can send 650 a transfer request to the mobile application 145 of the money transfer facilitator 140 to complete the transfer.

Upon receipt of the transfer request, the mobile application 145 of the money transfer facilitator 140 can perform a money transfer release process 655. The process 655 can perform a transfer of the funds to the identified account 175 of the recipient 110 and send a message to the mobile wallet application 121 of the recipient 110 indicating success or failure of the transfer. The mobile wallet application 121 of the recipient 110 can in turn update 660 a balance of the account 175, assuming a successful transfer, and notify 665 and 670 the recipient 110 of the transfer. Alternatively, or in addition, the money transfer facilitator 140 can notify the recipient 110 of the transfer.

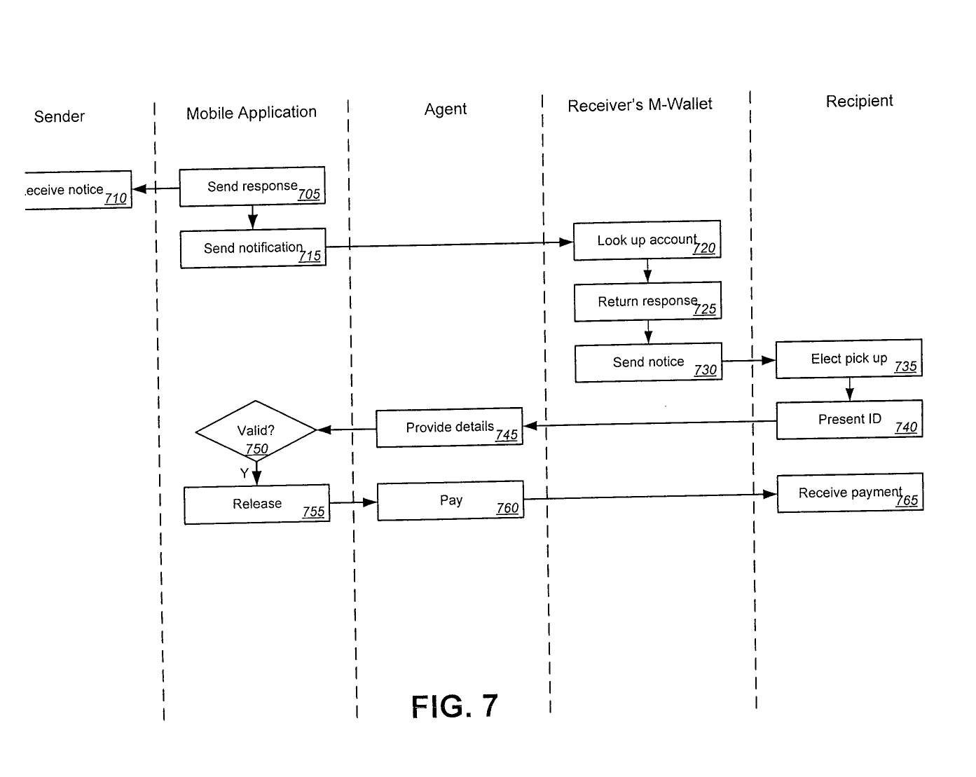

FIG. 7 illustrates a process for a transaction in which the recipient elects a “cash pick-up” option according to one embodiment of the present invention. In this example, processing begins after the money transfer send process has been initiated by the mobile application 145 of the money transfer facilitator 140 as described in the examples above. At this point, the mobile application 145 of the money transfer facilitator 140 can send 705 and 710 a response message to the sender 105, either the agent 135 of the money transfer facilitator 140 or the mobile wallet 125 of the sender 105, indicating the MTCN and/or that the transaction is available for payout. Also, the mobile application 145 of the money transfer facilitator 140 can send 715 a message to the mobile wallet application 121 of the recipient's 110 mobile network operator 120 indicating availability of the funds for transfer.

Upon receipt of the message indicating availability of the funds for transfer, the mobile wallet application 121 of the recipient's mobile network operator 120 can perform a look up process 720 to attempt to identify an account 175 associated with the recipient's 110 mobile wallet 130. However, if the recipient 110 does not have a mobile wallet, i.e., the recipient 110 does not subscribe to or enroll in that service, the mobile wallet application 121 of the recipient's mobile network operator 120 can return 725 a response to the mobile application 145 of the money transfer facilitator 140 indicating that the recipient 110 does not have an account/wallet. Additionally, the mobile wallet application 121 of the recipient's mobile network operator 120 and/or the money transfer facilitator 140 can send 730 a message the recipient 110, e.g., via the recipient's mobile device, notifying the recipient 110 of the availability of funds and inviting the recipient 110 to enroll in the mobile wallet service to receive the transfer or otherwise designate a destination for receiving the money transfer.

The recipient 110 can then elect, for example, via the recipient's mobile device, to enroll in the service to receive the funds transfer, to pick up the funds at an agent 135 of the money transfer facilitator 140 or designate a destination for receiving the money transfer. If the recipient 110 elects 735 to pick up the funds from an agent 135 of the money transfer facilitator 140, the recipient 110 can present 740 an identification, the MSISDN, IMSI, TMSI, the MTCN, provide an answer to a security question and/or other information to the agent 135 of the money transfer facilitator 140, e.g., at a retail outlet of the money transfer facilitator 140. The agent 135 of the money transfer facilitator 140 can in turn submit 745 this information and/or routing details for the transfer to the mobile application 145 of the money transfer facilitator 140. The mobile application 145 of the money transfer facilitator 140 can then perform a validation 750 of the data provided by the agent 135 and, if valid, perform a money transfer release process 755 to route the money transfer and/or instruct the agent 135 to pay 760 and 765 the transaction to the recipient.

It should be understood that, while described herein with reference to mobile devices, embodiments of the present invention are not limit to use with any type of device, wired or wireless, or any channel of communication. Rather, the sender, the recipient, or both can use any of a variety of channels to initiate a transfer, receive notification of the transfer, and/or direct funds in the transfer. For example, the sender and/or recipient can be a customer of a bank, a payment service (like PayPal), a local and/or long distance telephone service, a cable or satellite television service. In other examples, the sender and/or recipient may hold a loyalty card issued by a money transfer facilitator 140 (e.g., Western Union Gold Card holder who receives money is notified of transfer and can designate destination for receiving the transfer) or by a third party (e.g., receiver has loyalty number (represented by account number, telephone number, bar code, etc.) issued by a retailer such as a grocery store and sender can use that loyalty number to send money to an account designated by the recipient for recipient's use in making purchases at retailer. In yet other examples the sender and/or recipient can be registered with an action site like eBay. In any of these examples, transfers can be initiated by a sender through a channel appropriate to that sender, the transfer can be handled and directed by a money transfer facilitator 140, network operator, service provider, third-party, and/or other entities as appropriate for that channel, notification can be directed to the recipient through a channel appropriate to that recipient, and funds can be directed to a destination as determined as described above.

As noted above, a pull transaction model can additionally or alternatively be implemented. According to such embodiments, a money transfer can be initialed in a conventional manner via an agent of a money transfer facilitator. The sender of the transfer can provide an identifier for the transaction to the recipient. The recipient can in turn use the identifier, in combination with functionality of a mobile wallet application of a mobile device to request or “pull” the money transfer to an account associated with the mobile wallet application. In this way, the recipient can receive the transfer to the mobile wallet account even if the sender does not know that such a delivery is available.

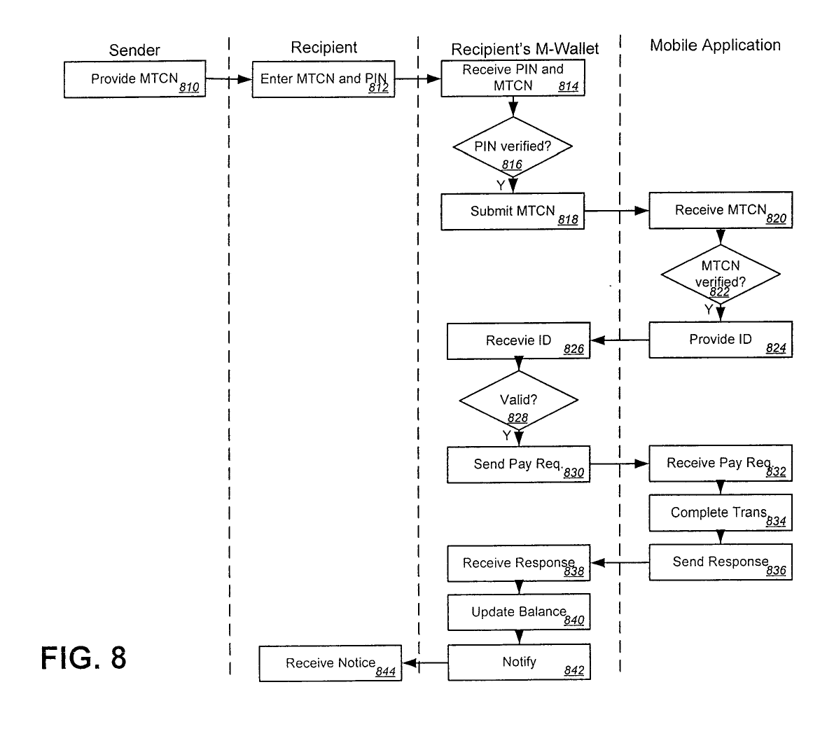

FIG. 8 illustrates a process for a pull transaction model according to one embodiment of the present invention. This example assumes that a money transfer transaction has been previously initiated by the sender 105. For example, the sender 105 can visit an agent 135 location as described above to make a payment and initiate a money transfer transaction as described above. Alternatively, the sender 105 can initiate the money transfer transaction via a website or Interactive Voice Response (IVR) phone system of the money transfer facilitator, bank, financial institution, or other entity as described above or as otherwise known in the art.

As illustrated in FIG. 8, the process begins with the sender 105 providing 810 an identifier for the transaction to the recipient 110. That is, the sender 105 can notify the recipient 110 in person, via a phone call, Instant Message (IM), text message, email message, etc. of an identifier for the money transfer transaction provided to the sender 105 by the agent 135 after the sender initiated the money transfer transaction. Alternatively the agent 135 may provide the transaction identifier to the recipient 110 via a phone call, Instant Message (IM), text message, email message, or other communication.

The recipient 110 can then enter 812 the received transaction identifier and perhaps a Personal Identification Number (PIN) for the recipients mobile wallet 130 into a mobile wallet application 121. For example, the recipient can enter 812 the PIN and transaction identifier via a keypad or other input device of a cell phone or other mobile device executing the mobile wallet application 121. The PIN and the transaction identifier for a previously initiated money transfer transaction can be received 814 by the mobile wallet application 121. The PIN can be verified 816 with the mobile wallet application 121 and, in response to verifying 816 the PIN, the transaction identifier can be sent 818 to an application 145 of a money transfer facilitator supporting the money transfer transaction.

The application 145 of the money transfer facilitator 140 can in turn receive 820 and verify 822 the transaction identifier. In response to verifying 822 the transaction identifier, the application 145 of the money transfer facilitator 140 can send 824 a recipient identifier to the mobile wallet application 121. The recipient identifier can indicate or identify an intended recipient of the money transfer transaction.

The recipient identifier from the application 145 of the money transfer facilitator 140 can be received 826 at the mobile wallet application 121. The mobile wallet application 121 can then validate 828 the recipient identifier. In response to validating 828 the recipient identifier, a payment request can be sent 830 from the mobile wallet application 121 to the application 145 of the money transfer facilitator 140.

The payment request can be received 832 at the application 145 of the money transfer facilitator 140 and the money transfer transaction can be completed 834, i.e., money transferred to a destination account, based at least in part on the payment request. In some cases, the payment request can indicate at least one destination account for the money transfer transaction, for example, an account associated with the mobile wallet application 121 and identified thereby. In such cases, completing 834 the money transfer transaction can comprise crediting the at least one destination account indicated by the payment request. Alternatively, the payment request can indicate a plurality of destination accounts for the money transfer transaction. In such cases, the payment request may further indicate a distribution of funds of the money transfer transaction to each of the destination accounts, for example as entered or indicated by a user of the mobile wallet application via a user interface thereof. In such cases, completing 834 the money transfer transaction can comprise crediting each of the destination accounts indicated by the payment request and can be based on the distribution indicated by the payment request.

A response can be sent 836 to the mobile wallet application 121 from the application 145 of the money transfer facilitator 140. The response can indicate completion of the money transfer transaction. The mobile wallet application 121 can receive 838 the response message from the application 145 of the money transfer facilitator 140. A balance maintained by the mobile wallet application 121 for the recipient's mobile wallet 130 can be updated 840 based on the response indicating completion of the money transfer transaction. In some cases, a notification can be provided 842 and 844 to a user of the mobile wallet application. For example, the notification can indicate the updated balance of recipient's mobile wallet 130.

As noted above, embodiments of the present invention provide methods and systems for supporting money transfer transactions initiated by and/or conducted through a variety of channels but are not limited to a wireless communication channel or systems including or using a wireless communication device. Rather, these systems and methods can be adapted to provide the sender choices of how to send or initiate the transfer and the recipient choices of pick up, divert, or receive the funds. In other words, these systems and methods can be adapted to allow the senders to get the money into the system in any way, and for the receivers to take the money out of the system in any way. Therefore, the following system illustrates and describes elements and features that may additionally or alternatively be used with systems to support such money transfer transactions. However, it should be understood that the elements of this system and the corresponding functions are described by way of example only and are not intended to limit the scope of the present invention. Further, it should be understood that the elements and functions of this system can vary depending upon the exact implementation. For example, in some implementations, support of mobile networks and/or mobile devices may not be important and thus may be excluded. In other cases, fewer, additional, or different interfaces may be utilized. Other variations and different implementations are contemplated and considered to be within the scope of the present invention.

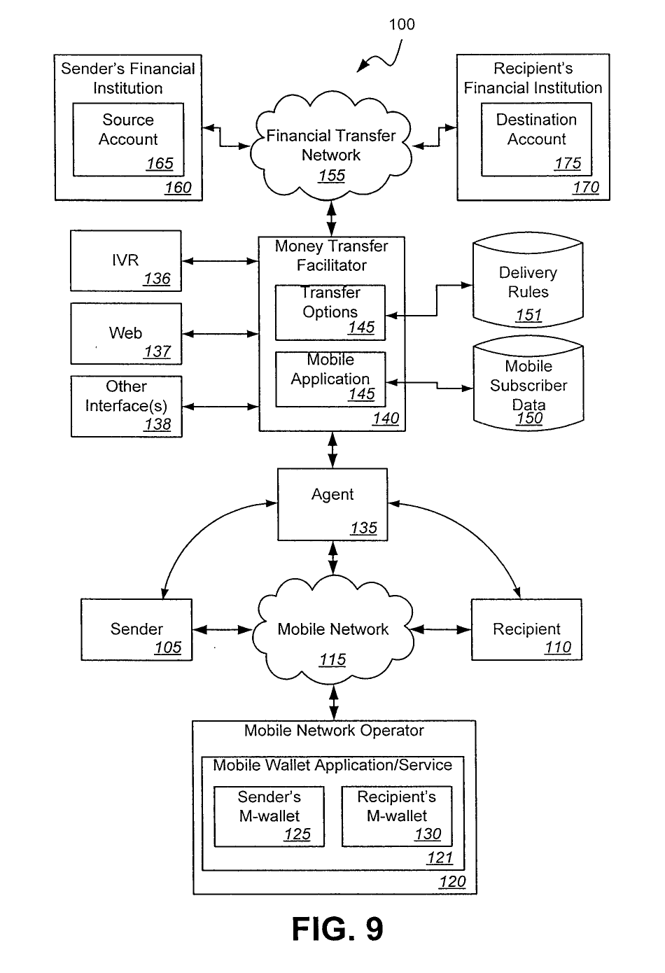

FIG. 9 is a block diagram illustrating another system for making financial transfers according to one embodiment of the present invention. Generally speaking, the system 100 illustrated here can comprise a system as described above with reference to FIG. 1 and can include some or all of the same components and may perform some or all of the same functions. For example, the system 100 can include a money transfer facilitator system 140 as described above that may be adapted to receive transaction information from a mobile wallet application 121 via a mobile network 115 as described in detail above.

As illustrated here, the money transfer facilitator system 140 can additionally or alternatively comprise one or more interfaces 136-138 for conducting money transfer transactions and a transfer options module 145 communicatively coupled with the one or more interfaces 136-138. For example, the one or more interfaces 136-138 can comprise at least one of an Interactive Voice Response (IVR) interface 136, a web interface 137, as well as or instead of an interface to an agent system 135, a telephone interface to a customer service representative, or other interfaces 138. The transfer options module 145 can be adapted to receive transaction information for a money transfer transaction from a sender 105 through at least one or the interfaces 136-138, provide a notification of the transaction to a recipient of the transaction, and select one or more delivery options for completing the money transfer transaction. For example, the delivery options can comprise at least one of delivering funds to a bank account of a recipient such as destination account 175 of the recipient's financial institution 170, delivering funds to a pre-paid account, delivering funds to a funds withholding system, delivering funds to a third party, delivering a draft check, delivering funds through an Automated Teller Machine (ATM), making funds available for pick up at an agent location. It should be noted that these delivery options are provided for illustrative purposes only and are not intended to limit the scope of the present invention. Rather, other payout options and methodologies as known in the art are contemplated and considered to be within the scope of the present invention.

In some cases, the transfer options module 145 can receive an indication of delivery options from a recipient 110 of the money transfer transaction and select one or more delivery options based on the indication. For example, the money transfer options module 145 can receive the indication of delivery options from the recipient 110 via one of the interfaces 136-138. In other cases, the transfer options module 145 can additionally or alternatively select one or more delivery options based on one or more delivery rules 151. For example, the one or more delivery rules 151 can include one or more rules defined by a recipient 110 of the money transfer transaction, one or more rules defined by a sender 105 of the money transfer transaction, and/or one or more rules defined by the money transfer facilitator. In some cases, the notification of the transaction can include an indication of one or more delivery options. In such cases, the transfer options module 145 may define a delivery rule based on the indication of delivery options received from the recipient 110 and may select one or more delivery options for completing a subsequent money transfer transaction based on the defined delivery rule.

In this way, the recipient 110 is able to make the determination of how to receive or divert funds originally put into the system for them by one or more “remitting” consumers, i.e., sender 105. For example the recipient 110 may choose to receive funds for the transfer as funds directed to a bank account 175 by supplying their account number and routing number via one of the interfaces 136-138, as value placed onto a prepaid card and delivered directly to the receivers residence, as funds placed into some other pre-established funds withholding system, as funds sent directly to another entity, e.g., bill payment, support payment, etc., as a draft check, as money available through an ATM, etc.

Such services can be provided to the recipient 110 in a variety of ways. For example, a notification can be provided to the recipient 110 via a mobile device and mobile network 115 as described above. Additionally or alternatively, a telephone call, telegram, email, SMS, U.S. postal letter, or other type of message can be sent to the recipient 110 providing the recipient 110 with notification of the transfer transaction and possibly instructions and/or options. Via one of the interfaces 136-138, e.g., by logging onto a website, calling an IVR, visiting an agent location, etc. depending upon the notification and/or instructions provided, the recipient can select a delivery option and/or provide instructions for the delivery. Further, in some cases, the recipient 110 may provide instructions for future transactions. That is, recipient defined rules can be defined by the recipient 110 via one of the interfaces 136-138 or through an agent and saved by the transfer options module 145 as a delivery rule 151 for future transfers of the same type, from the same sender, for all future transfers to the recipient, etc. As noted above and depending upon the exact implementation, the delivery rules 151 can additionally or alternatively include sender defined rules, i.e., rules defined by the sender and perhaps defining restrictions or conditions of the delivery, and/or money transfer facilitator defined rules, e.g., rules defined by the money transfer facilitator based on various governmental and/or banking rules, service conditions, etc. Any or all such delivery rules 151 related to a transfer can then be applied to future/subsequent transfer transactions and the recipient can be notified by the money transfer facilitator system, e.g., by email, U.S. mail, SMS, etc. Such notification options may be defined, for example as part of an applicable delivery rule.

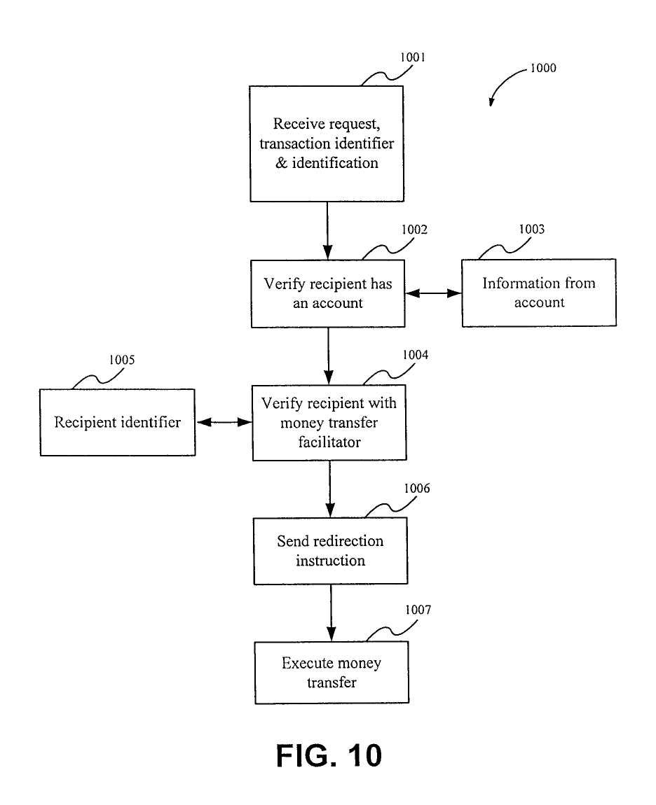

FIG. 10 illustrates a process 1000 for redirecting the funds of a money transfer according to one embodiment of the present invention. The redirection of funds is accomplished through a money redirection system that may be used by a money transfer facilitator, a bank, a mobile network operator, an account holder, etc. In other words, the money redirection system is a system that facilitates redirecting the funds of a money transfer and any entity using the money redirection system may redirect the funds at a recipient's request. In some embodiments, the money transfer has been initiated and the funds are enroute to a destination selected by the sender of funds. In such an embodiment, the money redirection system may be used, with or without the sender's knowledge, to redirect the funds to a destination requested by the recipient of the funds, such as to a preferred and/or more convenient destination. In other embodiments, the sender may not have selected a destination and the recipient can use the money redirection system to route and/or send the funds to a selected destination. Additionally, the money redirection system allows one entity to verify the recipient and/or route the funds using information from one or more third parties. For example, the entity using the money redirection system may be a bank and the bank may verify the recipient and/or route the funds using information from a money transfer facilitator and/or from a mobile network operator to redirect the funds to a recipient's account with the bank and/or the mobile network operator. Some embodiments disclosed herein allow a recipient can change the destination of funds to a more convenient location. While a sender may have good intentions to send money to a recipient, they may not recognize the most convenient or the recipients' desired location. Hence according to some embodiments disclosed herein, the recipient can redirect the funds from a less convenient destination to a more convenient destination. Moreover, a recipient may make the change from an original destination to another destination over the internet or through the phone.

The example in FIG. 10 assumes that a money transfer transaction has been previously initiated by a sender (e.g. sender 105). For example, the sender can initiate a money transfer by communicating with an agent (e.g. agent 135) of a money transfer facilitator, bank, mobile network operator, etc. as described above. Alternatively, the sender can initiate the money transfer transaction via a website, Interactive Voice Response (IVR) phone system, etc. A transaction identifier (MTCN) can be provided to the sender via the agent, a network (phone network, Internet, etc.), Instant Message (IM), sms message, etc. The sender can provide the transaction identifier to a recipient of the money transfer (e.g. recipient 110) in person, via a network (e.g. phone network, Internet, etc.), Instant Message (IM), sms message, etc. The transaction identifier can associate the recipient with the money transfer.

After receiving the transaction identifier, the recipient can send a redirection request to a money redirection system that requests that the funds of the money transfer be redirected from an intended destination (i.e. the destination the sender specified) to a new destination. The redirection request may include and/or be accompanied by the transaction identifier and recipient identification information that is used to validate the recipient's identity (e.g. name, address, account information, social security number, one or more answers to a security question, etc.). The recipient can interface with the money redirection system and thereby send the redirection request, the transaction identifier, and the recipient identification information in a variety of ways including, without limitation, through a mobile device (e.g. a cell phone), through a network (e.g. phone network, Internet, etc.), in person through an agent of the money transfer facilitator, etc.

At block 1001, the money redirection system receives the redirection request and/or the transaction identifier and recipient identification information. After receiving the redirection request, the money redirection system can then perform one or more verifications to ensure that the person and/or entity making the request is the recipient. A first verification can be performed by the money redirection system (shown at block 1002) to verify that the recipient holds an account with a account provider of the new destination of the funds. For example, the account provider may be a bank and the verification may include verifying that the recipient has an account with the bank (e.g. checking account). At block 1003, the money redirection system can receive information (e.g. recipient's account information) from a database associated with the account provider and compare this information with the recipient identification information and/or transaction identifier to determine if the recipient has an account.

In some embodiments, the database may be internal to the entity using the money redirection system. For example, a bank could be both the entity using the money redirection system and the account provider in which case the money redirection system could access the bank's database and receive account information for the recipient. Alternatively, in some embodiments the entity using the money redirection system and the account provider may not be the same and the database may be external the entity using the money redirection system. For example, a money transfer facilitator may be the entity using the money redirection system and the account provider may be a bank in which case the money redirection system may receive the recipient's bank account information from the bank's database. Although the example is described including a bank and money transfer facilitator, the money redirection system could be used by any entity (e.g. mobile network operator, etc.) to verify the recipient and redirect the funds.

At block 1004, a second verification can be performed by the money redirection system to verify that the person or entity making the redirection request is the recipient identified on the transaction identifier. To make this verification, the money redirection system can send the transaction identifier to the money transfer facilitator. The money transfer facilitator can in turn receive and verify the transaction identifier and send a recipient identifier to the money redirection system as shown in block 1005. The recipient identifier may include any information that indicates an intended recipient of the money transfer transaction including the recipient's name, address, date of birth, social security number, bank account information, one more security questions designed to test the recipient (e.g. mother's maiden name, etc.), information about the sender, and/or any other information that would be useful in making a verification. The money redirection system can compare the recipient identifier with the recipient identification information to ensure that the person or entity making the request is the recipient associated with the money transfer transaction. For example, the money redirection system may provide the recipient identifier to an agent of the entity using the money redirection system (e.g., a bank employee). The agent may then ask the recipient one or more questions provided by the recipient identifier (e.g. social security number, details about the money transfer transaction, etc.) and compare the recipient's answers to verify the recipient.

At block 1006, after the recipient has been positively verified, the money redirection system can send a redirection instruction to the money transfer facilitator that directs the money transfer facilitator to redirect the funds of the money transfer from the intended destination to the new destination. At block 1007, if the entity using the money redirection system is the money transfer facilitator, the money redirection system can execute or carry out the money transfer redirection. In addition, the money redirection system can calculate a fee for the money redirection service. The fee may depend on any or all of the following: the amount of funds transferred in the money transfer, any currency conversion, a location where the money transfer is initiated, a location to where the money transfer is redirected, an account to where the money transfer is redirected, etc. The fee may be applied to the money transfer by the money redirection system and paid by the recipient and/or sender or the fee may be provided to the recipient and/or the sender for payment.

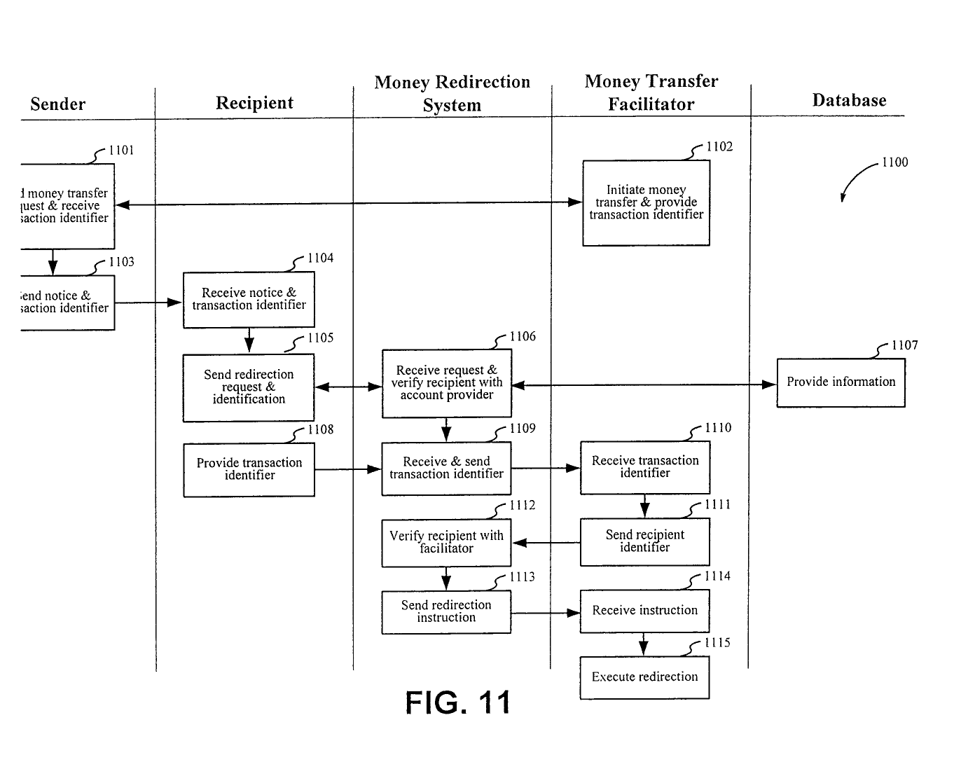

FIG. 11 illustrates another process for redirecting the funds of a money transfer 1100 according to an embodiment of the present invention. At blocks 1101 and 1002, the sender initiates a money transfer by sending a money transfer request to a money transfer facilitator. The money transfer request may specify an intended destination for the funds of the money transfer, such as a recipient's bank account, M-wallet account, etc or may specify the amount and recipient without specifying a destination. At block 1102, the money transfer facilitator initiates the money transfer process and sends a transaction identifier (MTCN) to the sender. The money transfer request and transaction identifier exchange can happen using any manner known in the art such as through a mobile device, through a network (Internet, etc.), in person through an agent, etc.

As noted above, the transaction identifier can be assigned or chosen for a transfer transaction. For example, the transaction identifier can be one or any combination of a mobile phone number, an email address, an instant messaging identification, a customer number, account information (e.g., stored value account identifier, bank account number and/or ABA routing number), tax number (e.g., Social Security Number or Taxpayer Identification Number), drivers' license number, state ID number, student ID number or other unique identifier. A customer number can be a preferred customer number or any other unique customer identifier issued by a money transfer facilitator, an agent of money transfer facilitator, a mobile network operator, a retailer, a bank, a service provider (e.g., payment service provider, auction service provider or Internet service provider) or any other party. This identifier can be used to identify the sender, the recipient, or both.

At blocks 1103 and 1104, the sender can provide the recipient with a notice of the money transfer and the transaction identifier as previously described. At block 1105, the recipient can send a redirection request to the money redirection system through any manner known in the art such as through a network (Internet, etc.), a mobile device, in person to an agent, etc. The redirection request may include recipient identification information such as the recipient's name, address, social security number, one or more answers to security questions designed to test the recipient, etc. The redirection request can request that the funds of the money transfer be redirected to a destination that the recipient may prefer, such as a bank account, M-wallet account, an investment account, a credit card account, etc. For example, if the sender specified an initial destination, the recipient can request that the funds be transferred to a new destination. Alternatively, if the sender did not specify a destination, the recipient can request a destination for the funds.

At block 1106, the money redirection system can receive the redirection request and recipient identification information and perform one or more verifications to ensure that the person and/or entity making the request is the intended recipient. One verification can be to verify that the recipient has an account with an account provider and the other verification can be to verify that the is the person and/or entity associated with the transaction identifier. At block 1106, the money redirection system can verify that the recipient has an account associated with an account provider that provides financial services for the new destination of the funds (e.g. verify that the recipient has a bank account). At block 1107, the money redirection system can receive information from a database associated with the account provider and verify that this information matches with the recipient identification information. To determine if the match is acceptable, a level of certainty for an acceptable match may be defined and the match could be compared against the level of certainty. For example, a bank may be using the money redirection system and the recipient may request that the funds be redirected to an account the recipient holds with the bank (e.g. a checking account). The money redirection system could use information from the bank's account database and compare this information with the recipient identification information to verify that the recipient has an account with the bank. Alternatively the account provider could be a mobile network operator and the money redirection system could use the mobile network operator's database to verify that the recipient holds an account, such as an M-wallet account, with the mobile network operator.

At block 1108, the money redirection system may verify that the person or entity making the redirection request is the recipient that the transaction identifier associates with the money transfer. To make this verification, the recipient can send the transaction identifier to the money redirection system, which in turn can receive the transaction identifier and send it to the money transfer facilitator as shown in blocks 1108 and 1109. At blocks 1110 and 1111, the money transfer facilitator can receive and verify the transaction identifier and, in response, sends a recipient identifier to the money redirection system. The recipient identifier may include information that identifies the recipient such as the recipient's name, address, social security number, answers to one or more security questions designed to test the recipient, etc. At block 1113, the money redirection system can receive the recipient identifier and verify that the recipient identification information matches with the recipient identifier.

The match could be compared against a predetermined level of certainty to determine if the matches are acceptable as previously described. For example, if the entity using the money redirection system is a mobile network operator, the mobile network operator may receive the transaction identifier and send it to the money transfer facilitator. In response, the mobile network operator may receive a recipient identifier from the money transfer facilitator that may include, among other things, information such as the recipient's name, social security number, one or more security questions designed to test the recipient, etc. The mobile network operator, via the money redirection system, may then match the recipient identifier with the recipient identification information received from the recipient and compare the results with the predetermined level of certainty to ensure that the person or entity making the request is the recipient associated with the money transfer transaction.

After verifying the recipient, the money redirection system can send a redirection instruction to the money transfer facilitator directing the money transfer facilitator to redirect the funds of the money transfer from the intended destination to the new destination as shown in block 1114. At blocks 1115 and 1116, the money transfer facilitator can receive the instruction from the money redirection system and in turn execute a money transfer redirection in accordance with the instruction. In addition, the money redirection, system can calculate a fee for the money redirection service. The fee may depend on any or all of the following: the amount of funds transferred in the money transfer, any currency conversion, a location where the money transfer is initiated, a location to where the money transfer is redirected, an account to where the money transfer is redirected, etc. The fee may be applied to the money transfer by the money redirection system and paid by the recipient and/or sender or the fee may be provided to the recipient and/or the sender for payment.

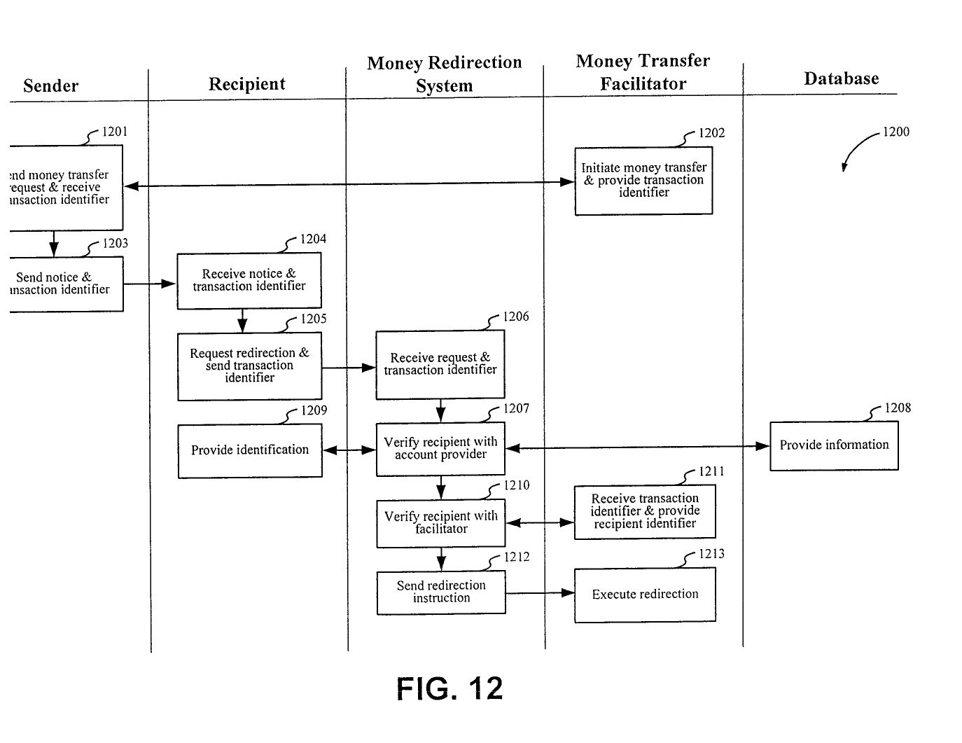

FIG. 12 illustrates another process for redirecting the funds of a money transfer 1200 according to another embodiment of the present invention. As described previously, blocks 1201 and 1202 show a sender and a money transfer facilitator interacting to initiate a money transfer transaction. Specifically, at block 1201, the sender sends a money transfer request to a money transfer facilitator. The money transfer request can specify an intended destination for the funds of the money transfer, such as a recipient's bank account, M-wallet account, etc. or may not specify a destination for the money transfer. In response, the money transfer facilitator can initiate the money transfer process and send a transaction identifier (MTCN) to the sender as shown in block 1202. As noted above, the transaction identifier can be assigned or chosen for a transfer transaction and can be any combination of numbers or other information.

At blocks 1203 and 1204, the sender can provide the recipient with a notice of the money transfer and/or the transaction identifier. At block 1205, the recipient can send a redirection request and/or the transaction identifier to the money redirection system. The money redirection system can receive the redirection request and/or transaction identifier from the recipient (block 1206) and, in response, begin one or more verification processes to verify that the person or entity making the redirection request is in fact the recipient such as verifying that the recipient has an account with an account provider and/or verifying that the recipient is the person and/or entity associated with the transaction identifier.

At block 1207, the money redirection system can verify that the recipient has an account associated with an account provider that provides services for the destination of the funds. At block 1208, the money redirection system can use a database (e.g. bank's database, mobile network operator's database, etc.) to obtain information about a recipient's account with the account provider, such as, for example, the recipient's account number, the recipient's name, the recipient's address, the recipient's social security number, etc.

At block 1209, the recipient can provide recipient identification information to the money redirection system as previously described. The recipient identification information may include any information that would assist the money redirection system in verifying the recipient such as the recipient's account information, name, address, social security number, phone number, one or more answers to security questions, etc. and/or information about the money transfer transaction, the sender, the intended destination, the purpose of the money transfer, etc. The recipient identification information could also include one or more unique identifiers that that are only known the sender and recipient.

At blocks 1208 and 1209, The money redirection system can receive the information from the database and the recipient identification information and verify that the recipient identification information matches with the account provider's database information. A level of certainty for an acceptable match may be predetermined and the match could be compared against the level of certainty to determine if the matches are acceptable. For example, the money redirection system could assign a match percentage to the match based on how similar the information and recipient identification information are and then compare the match percentage to a defined acceptable match percentage.

At block 1210, the money redirection system can verify that the person or entity making the redirection request is the person and/or entity the transaction identifier associates with the money transfer. As illustrated in block 1210, the money redirection system can send the transaction identifier to the money transfer facilitator. The money transfer facilitator can receive and verify the transaction identifier and, in response, sends a recipient identifier to the money redirection system as shown in block 1211. The recipient identifier can indicate an intended recipient of the money transfer transaction as previously described. The money redirection system can receive the recipient identifier and verify that the recipient identification information matches with the recipient identifier to an acceptable level when compared with the level of certainty as previously described. For example, the money redirection system could provide the recipient identifier to an agent using the money redirection system. The agent could ask the recipient one or more questions and compare the recipient's responses to one or more answers provided by the recipient identifier to determine if the recipient's response and the recipient identifier match. If the response and the identifier match to an acceptable level, the agent could input this match into the money redirection system to verify the recipient.

If the recipient is verified, the money redirection system can send a redirection instruction to the money transfer facilitator directing the money transfer facilitator to redirect the funds of the money transfer to the new destination provided by the recipient as shown in block 1212 (e.g. redirect the funds from the destination the sender intended to the new destination). At block 1213, the money transfer facilitator can receive the instruction and execute the money transfer redirection in accordance with the instruction. Although not shown in FIG. 12, in some embodiments the money transfer facilitator may be the entity using the money redirection system and the money redirection system may be configured to execute the money transfer redirection.

In addition, the money redirection system can calculate a fee for the money redirection service. The fee may depend on any or all of the following: the amount of funds transferred in the money transfer, any currency conversion, a location where the money transfer is initiated, a location to where the money transfer is redirected, an account to where the money transfer is redirected, etc. The fee may be applied to the money transfer by the money redirection system and paid by the recipient and/or sender or the fee may be provided to the recipient and/or the sender for payment.

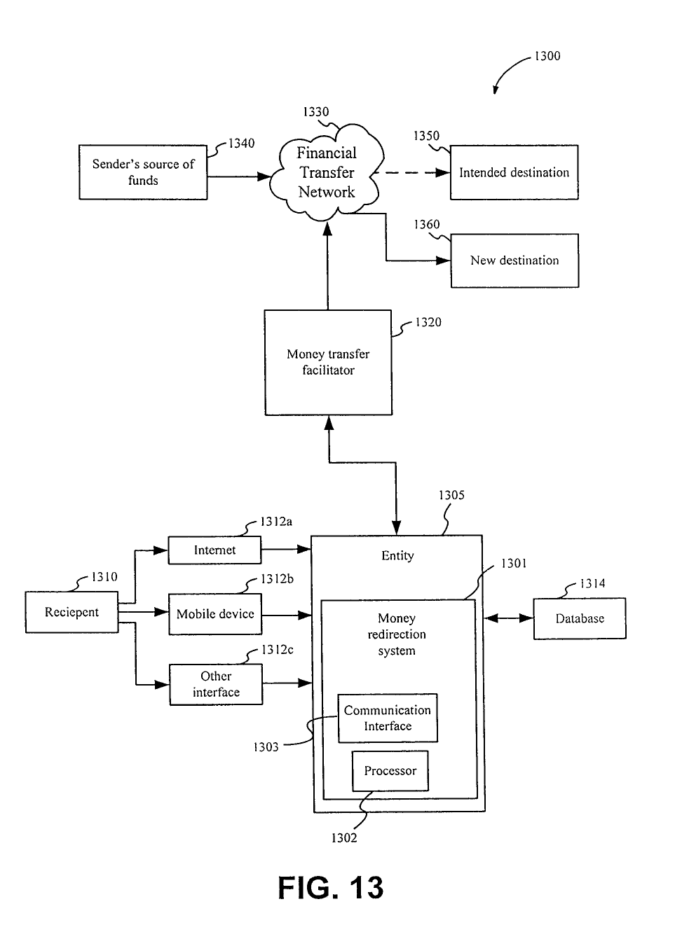

FIG. 13 is a block diagram illustrating a system that may be used to redirect a money transfer in accordance with the embodiments described herein. Block 1301 shows a money redirection system that can be used to redirect the funds of a money transfer such as from an intended destination selected by a sender to a new destination. The money redirection system 1301 is shown as being used by an entity 1305. The entity may be a financial institution such as a bank, a money transfer facilitator 1320, a mobile network operator 120, or any other entity that provides financial services. The money redirection system can include a communication interface 1303 that allows the money redirection system to interface with various persons and/or entities. FIG. 13 shows the money redirection system 1301 being able to interface with a recipient 1310, a money transfer facilitator 1320, and a database 1314. Those skilled in the art, however, will recognize that the communication interface 1303 may allow the money redirection system to interface with a variety of persons or entities not shown in FIG. 13.

The communication interface 1303 can interface with the recipient 1310 through various applications and devices 1312. For example, using the Internet 1312a, a mobile device 1312b, or any other interface 1312c (e.g. an agent, etc.), the recipient 1310 can send and the money redirection system 1301 can receive the redirection request, the transaction identifier (MTCN), the recipient identification information, and/or any other information that may be required to perform the money transfer redirection. The communication interface 1303 can further interface with a database 1314 to obtain any information, such as any verification and/or account information that may be necessary as previously described. The database 1314 may be internal to the entity 1305 and/or internal to the money redirection system 1301 or the database may be external to the entity 1305 and/or the external to the money redirection system.

The communication interface 1303 can interface with the money transfer facilitator 1320 to provide information to and/or obtain information from the money transfer facilitator. For example, the communication interface 1303 allows the money redirection system and the money transfer facilitator to communicate with each other and thereby provide the transaction identifier, the recipient identifier, and the redirection instruction as previously described. Furthermore, the communication interface 1303 may be designed to allow various persons and/or entities associated with the money transfer transaction to interface with each other. For example, the communication interface 1303 could be designed so that any communication received from the recipient 1310 is automatically routed to the money transfer facilitator 1320 and/or a bank and vice versa.

The money redirection system 1301 can also include a processor 1302 that receives instructions and/or data and processes the instructions and/or data. The processor can be designed to verify that the recipient identification information provided by the recipient matches with the database information and/or the recipient identifier to a predetermined level of certainty. For example, the processor can be designed to receive the recipient identification information and compare it with the database information and/or the recipient identifier and assign a match percentage and/or a level of confidence for the matches. An acceptable match percentage and/or level of confidence can be defined and the processor can compare the matches with the acceptable match percentage and/or level of confidence to determine if the matches are acceptable.

Furthermore, the processor could be designed to calculate a fee for the money transfer redirection service. The fee could depend on any or all of the following: the amount of funds transferred in the money transfer, any currency conversion that may results because of the redirection, the location the money transfer was initiated, a location to where the funds of the money transfer are redirected, an account to where the money transfer is redirected, etc. The processor may further apply the fee to the money transfer so that the fee will be paid by the recipient upon receipt of the funds of the money transfer. Alternatively, the fee may be applied so that the recipient pays the fees upon requesting the money transfer redirection service.

The money transfer facilitator 1320 can be communicatively coupled with a financial transfer network 1330. Also communicatively coupled with the financial transfer network 1330 can be a sender's source of funds 1340 (e.g. bank account, M-wallet, credit or debit card, cash provided to an agent, etc.), and one or more destinations for the funds, such as an intended destination 1350 (e.g. bank account, M-wallet, credit or debit card, cash provided by an agent, etc.), and a new destination 1360 (e.g. bank account, M-wallet, credit or debit card, cash provided by an agent, etc.). Generally speaking and as understood by one skilled in the art, the money transfer facilitator 1320 may have access to the sender's source account 1340 and/or one or more destination accounts 1350 and 1360 to affect a money transfer via the financial transfer network 1330 and thereby redirect the funds from an intended destination 1350 selected by the sender (shown by the dashed line) to a new destination 1360 selected by the recipient (shown by the solid line). For example, via the financial transfer network 1330, the money transfer facilitator 1320 may redirect the funds from a recipient's bank account to a recipient's M-wallet.

By way of example and without limitation, the entity 1305 may be a bank that uses the money redirection system 1301 to provide money transfer redirection services to the bank's customers. The recipient 1310 may interface with the money redirection system 1301 via the bank's website, in person through an agent of the bank, via an automated teller machine (ATM), etc. and thereby provide the redirection request, transaction identifier (MTCN), recipient identification information, and/or any other necessary information to the money redirections system 1301. The recipient may be requesting that the funds be redirected to a bank account the recipient has with the bank or that the funds be available for cash pickup or any other type of redirection. After the recipient provides the bank with the necessary information, the processor 1302 may perform one or more verifications (e.g. verify the recipient has an account with an account provider and that the recipient is the person identified by the transaction identifier) to ensure that the recipient is the person and/or entity associated with the money transfer.

To verify that the recipient has an account with an account provider, the money redirection system can communicate with the bank's database 1314 via the communication interface to obtain information about the recipient's account. The processor 1302 can then compare the recipient identification information with the bank's account information to verify that the recipient has an account with the bank such as a checking or savings account, etc. For example, the recipient's account information may be provided to an agent of the bank and the agent could compare the account information with the recipient identification information (e.g. a driver's license) and provide the results to the processor. Alternatively the recipient identification information could be input into the money redirection system by the agent of the bank and/or by the recipient via the communication interface 1303 (e.g. the bank's website, ATM, etc.) and the processor could match this information with the bank's account information.

To verify that the recipient is the person identified by the transaction identifier, the money redirection system 1301 can communicate with the money transfer facilitator 1320 via the communication interface 1303 to send the transaction identifier to the money transfer facilitator and receive the recipient identifier from the money transfer facilitator 1320. The processor 1302 can then verify that the recipient identification information matches with the recipient identifier to the predetermined level of certainty. For example, the recipient identifier could be provided to an agent of a bank (bank employee) and the bank's agent could ask the recipient one or more questions about the recipient identifier. The recipient's responses could be provided to the processor, such as by the bank's agent inputting the responses, and the processor could determine if the recipient is verified based on the responses. Alternatively, the recipient and/or the agent could input the recipient identification information (e.g. responses, social security number, unique identifier, etc.) into the money redirection system via the communication interface (e.g. bank's website, ATM, etc.) and the processor could compare the recipient identification information with the recipient identifier and determine if the recipient is verified.

If the matches are acceptable, the money redirection system 1301 could then send the redirection instruction to the money transfer facilitator 1320 via the communication interface 1303 directing the money transfer facilitator to redirect the funds of the money transfer from the intended destination 1350 to the new destination 1360. For example, the money redirection system could send a redirection instruction directing the money transfer facilitator to redirect the money transfer funds to the recipient's bank account and/or make the funds available for cash pickup or any other destination the recipient requests. The money transfer facilitator 1320 then communicates with the financial transfer network 1330 to redirect the funds such as from the intended destination 1350 selected by the sender (shown by the dashed line) to the new destination 1360 selected by the recipient (shown by the solid line).

The above example is not meant to limit the invention in any way. Although the entity 1305 described in the example is a bank, the entity 1305 may be a mobile network operator 120, a money transfer facilitator 1320, or any other entity that provides financial services. For example, the entity 1305 could be a mobile network operator and the recipient could request that the funds be redirected to a M-wallet or the entity could be a money transfer facilitator 1320 and the recipient could request cash pickup from a branch location of the money transfer facilitator. In addition, the above examples describe the funds being transferred to an existing account, such as a bank account. However, the money redirection system can be used to redirect funds to an account that is established after the money transfer is initiated. For example, the redirection request could comprise a request to redirect funds to an account that will be created in the near future. Those skilled in the art will recognize that the money redirection system could be used by a variety of entities for a variety of money transfer redirection purposes and is not limited by the embodiments described herein.

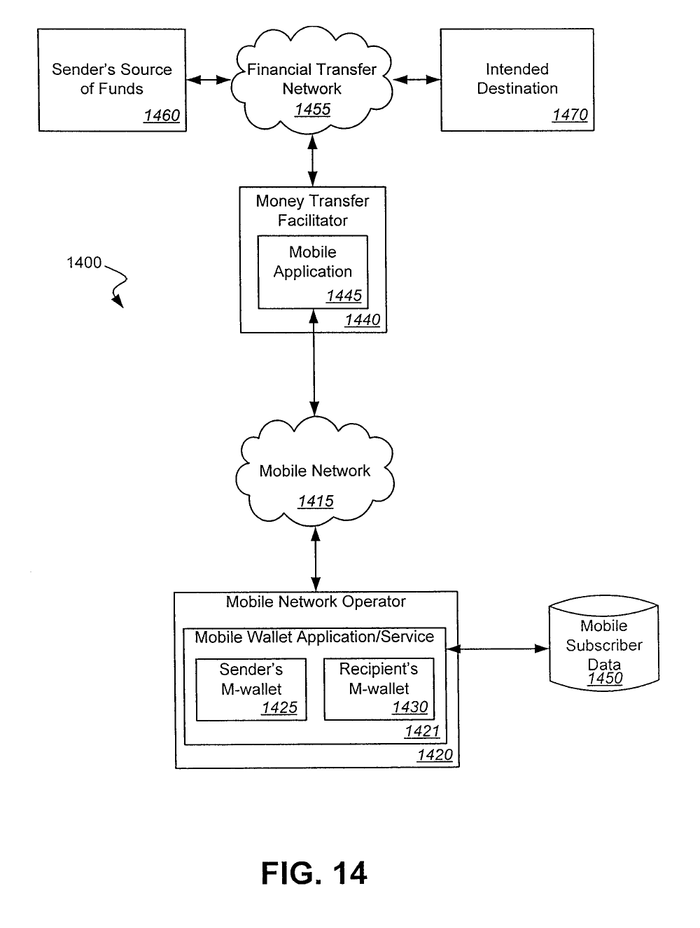

FIG. 14 is a block diagram illustrating another system 1400 for making financial transfers according to one embodiment of the present invention. FIG. 14 is similar to FIG. 1 in that a money transfer facilitator 1440 can be communicatively coupled with a financial transfer network 1455. Also communicatively coupled with financial transfer network 1455 may be a sender's source of funds 1460 (e.g. a financial institution, a virtual or e-money wallet 1425, an online account, a credit or debit card, cash provided to an agent of the money transfer facilitator or provided online, etc.) and an intended destination for the funds 1470 (e.g. a financial institution, a virtual or e-money wallet 1430, an online account, cash provided by an agent of the money transfer facilitator, etc.). A mobile network operator system 1420 may be communicatively coupled with a mobile network 1415 (e.g. a cellular or other wireless network) and further coupled with a mobile application 1445 of the money transfer facilitator 1440 thereby eliminating the need for an agent such as agent 135 in FIG. 1 (i.e. the mobile network operator system 1420 can provide a channel by which entities (e.g. the sender) can access the services of the money transfer facilitator 1440).

In a specific embodiment, the mobile network operator system 1420 may facilitate in redirecting the funds from the intended destination 1470 to a new destination such as the recipient's M-wallet 1430. The mobile network operator system 1420 can include and/or execute a mobile wallet application 1421 or service that maintains mobile wallets, such as sender's M-wallet 1425 and recipient's M-wallet 1430, for one or more subscribers. The mobile wallets, such as sender's M-wallet 1425 and recipient's M-wallet 1430, can each comprise information related to the device and accounts of the entity for which the mobile wallet is maintained. Mobile subscriber data 1450, such as the information related to the device and accounts of the entity, may be maintained in a database or other repository. The mobile network operator system 1420 may be communicatively coupled with the database or other repository so that the mobile network operator system 1420 may access the mobile subscriber data 1450. In some embodiments, the mobile wallet application 1421 may access the mobile subscriber data 1450 as shown in FIG. 14.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable medium, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for redirecting funds during a money transfer process, the method occurring at a redirection system, the method comprising:
receiving a redirection request from a recipient of the money transfer that the funds of the transfer be redirected from an intended destination to a new destination, wherein the request comprises identification information of the recipient;
communicating with a database associated with an account provider to verify that the recipient has an account associated with the account provider;
receiving a transaction identifier from the recipient, wherein the transaction identifier associates the money transfer with the recipient;
sending the transaction identifier to a money transfer facilitator, wherein the transaction identifier is used to obtain a recipient identifier from the money transfer facilitator;
receiving the recipient identifier from the money transfer facilitator;
verifying that the identification information provided by the recipient matches with the recipient identifier received by the money transfer facilitator to a predetermined level of certainty; and
in the event that the match is acceptable, sending a redirection instruction to the money transfer facilitator to redirect the funds of the money transfer from the intended destination to the new destination.

2. The method for redirecting funds during a money transfer process as in claim 1, wherein the money redirection system is used by an agent of an entity using the money redirection system and at least one of the steps of receiving, communicating, sending, and verifying are carried out with the agent's assistance.

3. The method for redirecting funds during a money transfer process as in claim 1, wherein the money redirection system is used by the money transfer facilitator and the method further comprises:
executing a money transfer in accordance with the instruction whereby the money transfer funds are redirected from the intended destination to the new destination.

4. The method for redirecting funds during a money transfer process as in claim 1, wherein the money redirection system is used by a bank and the money redirection system communicates with the bank's database to verify that the recipient holds an account with the bank.

5. The method for redirecting funds during a money transfer process as in claim 4, wherein the new destination for the funds of the money transfer is the account the recipient holds with the bank.

6. The method for redirecting funds during a money transfer process as in claim 1, wherein the money redirection system is used by a mobile network operator, wherein the money redirection system communicates with the mobile network operator's database to verify that the recipient has a mobile device account with the mobile network operator, and wherein the new destination for the funds associated with the account.

7. The method for redirecting funds during a money transfer process as in claim 1, further comprising:
calculating a fee, wherein the fee depends on any or all of the following: the amount of funds transferred in the money transfer, any currency conversion, a location where the money transfer is initiated, a location to where the money transfer is redirected, and an account to where the money transfer is redirected.

8. The method for redirecting funds during a money transfer process as in claim 7, wherein the fee is applied to the money transfer by the money redirection system before the money transfer redirection is executed, the fee being used to pay for the service of the money redirection system.

9. A method for redirecting funds during a money transfer process, the method occurring at a redirection system, the method comprising:
receiving a redirection request and a transaction identifier from a recipient of the money transfer, wherein the redirection request requests that the money transfer be redirected from an intended destination to a new destination, and wherein the transaction identifier associates the recipient with the money transfer;
sending the transaction identifier to a money transfer facilitator, wherein the transaction identifier is used to obtain a recipient identifier from the money transfer facilitator;
receiving the recipient identifier from the money transfer facilitator;
communicating with the recipient to obtain identification information of the recipient;
communicating with a database associated with an account provider to verify that the recipient has an account associated with the account provider;
verifying that the identification information provided by the recipient matches with the recipient identifier to a predetermined level of certainty; and
in the event the match is acceptable, sending a redirection instruction to the money transfer facilitator to redirect the money transfer from the intended destination to the new destination

10. The method for redirecting funds during a money transfer process as in claim 9, wherein the money redirection system is used by an agent of an entity using the money redirection system and the steps of receiving, communicating, sending, and verifying are carried out with the agent's assistance.

11. The method for redirecting funds during a money transfer process as in claim 9, wherein the money redirection system is used by the money transfer facilitator and the method further comprises:
executing a money transfer in accordance with the instruction whereby the money transfer funds are redirected from the intended destination to the new destination.

12. The method for redirecting funds during a money transfer process as in claim 9, wherein the money redirection system is used by a bank and the money redirection system communicates with the bank's database to verify that the recipient holds an account with the bank.

13. The method for redirecting funds during a money transfer process as in claim 11, wherein the new destination for the funds of the money transfer is the account the recipient holds with the bank.

14. The method for redirecting funds during a money transfer process as in claim 9, wherein the money redirection system is used by a mobile network operator, wherein the money redirection system communicates with the mobile network operator's database to verify that the recipient has mobile device account with the mobile network operator, and wherein the new destination for the funds is associated with the account.

15. The method for redirecting funds during a money transfer process as in claim 9, further comprising:
calculating a fee, wherein the fee depends on any or all of the following: the amount of funds transferred in the money transfer, any currency conversion, a location where the money transfer is initiated, a location to where the money transfer is redirected, and an account to where the money transfer is redirected.

16. The method for redirecting funds during a money transfer process as in claim 15, wherein the fee is applied to the money transfer by the money redirection system before the money transfer redirection is executed, the fee being used to pay for the service of the money redirection system.

17. A money redirection system for redirecting funds during a money transfer process, the system comprising:
a communication interface that is adapted to:
receive a redirection request and a transaction identifier from a recipient of the money transfer, wherein the redirection request requests that the money transfer be redirected from an intended destination to a new destination, and wherein the transaction identifier associates the money transfer with the recipient,
send the transaction identifier to a money transfer facilitator, wherein the transaction identifier provides the money redirection system with a recipient identifier from the money transfer facilitator,
receive the recipient identifier from the money transfer facilitator,
communicate with the recipient to obtain identification information of the recipient, and
send an instruction to the money transfer facilitator to redirect the money transfer from the intended destination to the new destination; and
a processor that is configured to:
verify that the identification information provided by the recipient matches with information kept on the database associated with an account provider to a predetermined level of certainty, and
verify that the identification information provided by the recipient matches the recipient identifier to a predetermined level of certainty.

18. The money redirection system for redirecting funds during a money transfer process as in claim 17, wherein the money redirection system is used by the money transfer facilitator and wherein the processor is further configured to execute the money transfer in accordance with the instruction whereby the funds are redirected from the intended destination to the new destination.

19. The money redirection system for redirecting funds during a money transfer process as in claim 17, wherein the account provider is a financial institution and the money redirection system is used by the financial institution, and wherein the processor verifies that the recipient holds an account with the financial institution.

20. The money redirection system for redirecting funds during a money transfer process as in claim 17, wherein the processor is further configured to calculate a fee, wherein the fee depends on any or all of the following: the amount of funds transferred in the money transfer, any currency conversion, a location where the money transfer is initiated, a location to where the money transfer is redirected, and an account to where the money transfer is redirected.

21. A method for redirecting funds during a money transfer transaction, the method occurring at a redirection system, the method comprising:
verifying that a recipient of the money transfer funds is associated with an account;
verifying that the recipient is associated with the money transfer transaction; and
in the event that the recipient is verified with the account and the money transfer transaction, redirecting the funds to the account.
